(19) United States
(12) Patent Application Publication
(10) Pub. No.: US 2026/0174632 A1
(43) Pub. Date: Jun. 25, 2026

(54) System and Method for Aseptically Transferring Fluid

(71) Applicant: Applied Cells Inc., Santa Clara, CA (US)

(72) Inventors: Yuchen Zhou, San Jose, CA (US); Fengxiang Pang, Qinhuangdao (CN); Jinlong Fan, Qinhuangdao (CN); Xinglong Wang, Qinhuangdao (CN)

(21) Appl. No.: 19/199,329

(22) Filed: May 5, 2025

Related U.S. Application Data
(63) Continuation-in-part of application No. 18/991,162, filed on Dec. 20, 2024, now Pat. No. 12,329,721.

(51) Int. Cl. A61J 1/20

(52) U.S. Cl. CPC A61J 1/2096; A61J 1/201; A61J 1/2058; A61J 1/2082

(57) ABSTRACT

A system for aseptically transferring a liquid substance comprises a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member; and an outlet line fluidically connected to the second channel of the piercing member at one end and sealed at the other end; and a sterilized pouch enclosing the sterilized vial and the piercing member and operably allowing the piercing member to puncture the sterilized septum without breaching the sterilized pouch when one of the sterilized vial and the piercing member is manually pushed against the other one of the sterilized vial and the piercing member from an exterior of the sterilized pouch.

### CROSS-REFERENCE TO RELATED APPLICATIONS

The present application is a continuation-in-part of application Ser. No. 18/991,162, filed on Dec. 20, 2024, which is incorporated herein by reference in its entirety.

### BACKGROUND OF THE INVENTION

The present invention relates generally to a system and method for aseptically transferring fluid, and more particularly, but not exclusively, to a system and method for aseptically transferring a liquid substance from a vial to a receiving container.

Contamination during manufacturing of biopharmaceutical products may have serious health effects on patients, especially biologics that are introduced to the patients by injection because this mode of drug delivery may bypass the body's natural defenses. Accordingly, biologics are manufactured in aseptic processing facilities that require cleanrooms with stringent controls and close monitoring to minimize the risks of microbial and pyrogen contamination. The strict requirements on sterility and cleanliness during manufacturing have prompted the biopharmaceutical industry to increasingly use closed processing systems equipped with single-use technologies. The use of such closed processing systems to manufacture biologics, however, still requires aseptic transfer of ingredients from containers, such as common glass vials sealed by septa, to the processing systems. Glass vials are considered to be standard containers in the pharmaceutical industry owing to their extensive clinical history and long-term stability with various drugs. The transfer process of ingredients from vials to closed processing systems may still need to be performed in a cleanroom with a stringent sterility and cleanliness standard, which will inevitably inflate the manufacturing cost of biologics.

For the foregoing reason, there is a need for a system and method for aseptically transferring a liquid substance from a vial to a receiving container of a processing system or equipment.

### SUMMARY OF THE INVENTION

The present invention is directed to a system that satisfies this need. A system having features of the present invention for aseptically transferring a liquid substance comprises a sterilized vial filled with the liquid substance and sealed with a sterilized septum; a sterilized fluidic assembly comprising a piercing member including therein first and second channels and having a tip end that operably punctures the sterilized septum, the first and second channels having first and second tip openings at the tip end of the piercing member; a manual air pump; an inlet line that fluidically connects the manual air pump to the first channel of the piercing member; and an outlet line fluidically connected to the second channel of the piercing member at one end and sealed close at the other end; and a sterilized pouch enclosing the sterilized vial and the piercing member and operably allowing the piercing member to puncture the sterilized septum without breaching the sterilized pouch when one of the sterilized vial and the piercing member is manually pushed against the other one of the sterilized vial and the piercing member from an exterior of the sterilized pouch.

According to another aspect of the present invention, a method having features of the present invention for manufacturing a system for aseptically transferring a liquid substance comprises the steps of sterilizing a vial and a septum; aseptically filling the sterilized vial with the liquid substance and sealing the sterilized vial with the sterilized septum; providing a fluidic assembly that includes a piercing member including therein first and second channels and having a tip end that operably punctures the sterilized septum, the first and second channels having first and second tip openings at the tip end of the piercing member; a manual air pump; an inlet line that fluidically connects the manual air pump to the first channel of the piercing member; and an outlet line fluidically connected to the second channel of the piercing member at one end and sealed close at the other end; sterilizing the fluidic assembly; and assembling the vial and the fluidic assembly and enclosing the vial and the piercing member with a sterilized pouch in an aseptic environment, wherein the sterilized pouch allows the piercing member to puncture the sterilized septum without breaching the sterilized pouch when one of the sterilized vial and the piercing member is manually pushed against the other one of the sterilized vial and the piercing member from an exterior of the sterilized pouch.

According to still another aspect of the present invention, a method having features of the present invention for aseptically transferring a liquid substance comprises the steps of providing a transfer system including a sterilized vial filled with the liquid substance and sealed with a sterilized septum; a sterilized fluidic assembly including a piercing member including therein first and second channels and having a tip end that operably punctures the sterilized septum, the first and second channels having first and second tip openings at the tip end of the piercing member; a manual air pump filled with sufficient air to propel all of the liquid substance out of the sterilized vial; an inlet line that fluidically connects the manual air pump to the first channel of the piercing member; and an outlet line fluidically connected to the second channel of the piercing member at one end and sealed close at the other end; and a sterilized pouch enclosing the sterilized vial and the piercing member; aseptically connecting the outlet line to an external line for receiving the liquid substance; puncturing the sterilized septum with the piercing member by manually pushing one of the sterilized vial and the piercing member against the other one of the sterilized vial and the piercing member from an exterior of the sterilized pouch without breaching the sterilized pouch, thereby aseptically establishing fluidic communications between the sterilized vial and the inlet and outlet lines; and expelling air from the manual air pump into the sterilized vial disposed in an inverted orientation to propel the liquid substance in the sterilized vial through the outlet line and into the external line.

According to yet another aspect of the present invention, a method having features of the present invention for aseptically transferring a liquid substance comprises the steps of providing a transfer system including: a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member; a syringe comprising a barrel and a plunger fitted in the barrel; an inlet line fluidically connects the syringe to the first channel of the piercing member; an in-line gas or air filter inserted in or fluidically connected to the inlet line for filtering air flowing through the inlet line; and an outlet line fluidically connected to the second channel of the piercing member at one end and sealed close at the other end; and a sterilized pouch enclosing the sterilized vial and the piercing member; aseptically connecting the outlet line to an external line for receiving the liquid substance; puncturing the sterilized septum with the piercing member by manually pushing one of the sterilized vial and the piercing member against the other one of the sterilized vial and the piercing member from an exterior of the sterilized pouch without breaching the sterilized pouch, thereby aseptically establishing fluidic communications between the sterilized vial and the inlet and outlet lines; removing the plunger from the barrel of the syringe or disconnecting the syringe from the inlet line; and pumping the liquid substance from the sterilized vial disposed in an inverted orientation to the external line using an external pump.

According to still yet another aspect of the present invention, a system having features of the present invention for aseptically transferring a liquid substance comprises a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member, respectively; and an outlet line fluidically connected to the second channel of the piercing member at one end and sealed close at the other end; and a sterilized pouch enclosing the sterilized vial and the piercing member and operably allowing the piercing member to puncture the sterilized septum without breaching the sterilized pouch when one of the sterilized vial and the piercing member is manually pushed against the other one of the sterilized vial and the piercing member from an exterior of the sterilized pouch.

According to yet still another aspect of the present invention, a method having features of the present invention for manufacturing a system for aseptically transferring a liquid substance comprises the steps of sterilizing a vial and a septum; aseptically filling the sterilized vial with the liquid substance and sealing the sterilized vial with the sterilized septum; providing a fluidic assembly that includes: a piercing member including therein first and second channels and having a tip end that operably punctures the sterilized septum, the first and second channels having first and second tip openings at the tip end of the piercing member; and an outlet line fluidically connected to the second channel of the piercing member at one end and sealed close at the other end; sterilizing the fluidic assembly; and assembling the vial and the fluidic assembly and enclosing the vial and the piercing member with a sterilized pouch in an aseptic environment, wherein the sterilized pouch allows the piercing member to puncture the sterilized septum without breaching the sterilized pouch when one of the sterilized vial and the piercing member is manually pushed against the other one of the sterilized vial and the piercing member from an exterior of the sterilized pouch.

According to still yet another aspect of the present invention, a method having features of the present invention for aseptically transferring a liquid substance comprises the steps of providing a transfer system including: a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member; and an outlet line fluidically connected to the second channel of the piercing member at one end and sealed close at the other end; and a sterilized pouch enclosing the sterilized vial and the piercing member; aseptically connecting the outlet line to an external line for receiving the liquid substance; puncturing the sterilized septum with the piercing member by manually pushing one of the sterilized vial and the piercing member against the other one of the sterilized vial and the piercing member from an exterior of the sterilized pouch without breaching the sterilized pouch, thereby aseptically establishing fluidic communication between the sterilized vial and the outlet line; and pumping the liquid substance from the sterilized vial disposed in an inverted orientation to the external line using an external pump.

According to yet still another aspect of the present invention, a method having features of the present invention for aseptically transferring a liquid substance comprises the steps of providing a transfer system including: a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member; and an outlet line fluidically connected to the second channel of the piercing member at one end and sealed close at the other end; and a sterilized pouch enclosing the sterilized vial and the piercing member; aseptically connecting the outlet line to an external line for receiving the liquid substance; puncturing the sterilized septum with the piercing member by manually pushing one of the sterilized vial and the piercing member against the other one of the sterilized vial and the piercing member from an exterior of the sterilized pouch without breaching the sterilized pouch, thereby aseptically establishing fluidic communication between the sterilized vial and the outlet line; and manually pressurizing a gas or air environment inside the sterilized pouch to propel the liquid substance in the sterilized vial disposed in an inverted position through the outlet line and into the external line.

According to still yet another aspect of the present invention, a system having features of the present invention for aseptically transferring a liquid substance comprises a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member, respectively; an inlet line fluidically connected to the first channel of the piercing member; an in-line gas or air filter inserted in or fluidically connected to the inlet line for filtering air flowing through the inlet line; and an outlet line fluidically connected to the second channel of the piercing member at one end and sealed close at the other end; and a sterilized pouch enclosing the sterilized vial and the piercing member and operably allowing the piercing member to puncture the sterilized septum without breaching the sterilized pouch when one of the sterilized vial and the piercing member is manually pushed against the other one of the sterilized vial and the piercing member from an exterior of the sterilized pouch.

According to yet still another aspect of the present invention, a method having features of the present invention for manufacturing a system for aseptically transferring a liquid substance comprises the steps of sterilizing a vial and a septum; aseptically filling the sterilized vial with the liquid substance and sealing the sterilized vial with the sterilized septum; providing a fluidic assembly that includes: a piercing member including therein first and second channels and having a tip end that operably punctures the sterilized septum, the first and second channels having first and second tip openings at the tip end of the piercing member; an inlet line fluidically connected to the first channel of the piercing member; an in-line gas or air filter inserted in or fluidically connected to the inlet line for filtering air flowing through the inlet line; and an outlet line fluidically connected to the second channel of the piercing member at one end and sealed close at the other end; sterilizing the fluidic assembly; and assembling the vial and the fluidic assembly and enclosing the vial and the piercing member with a sterilized pouch in an aseptic environment, wherein the sterilized pouch allows the piercing member to puncture the sterilized septum without breaching the sterilized pouch when one of the sterilized vial and the piercing member is manually pushed against the other one of the sterilized vial and the piercing member from an exterior of the sterilized pouch.

According to still yet another aspect of the present invention, a method having features of the present invention for aseptically transferring a liquid substance comprises the steps of providing a transfer system including: a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member; an inlet line fluidically connected to the first channel of the piercing member; an in-line gas or air filter inserted in or fluidically connected to the inlet line for filtering air flowing through the inlet line; and an outlet line fluidically connected to the second channel of the piercing member at one end and sealed close at the other end; and a sterilized pouch enclosing the sterilized vial and the piercing member; aseptically connecting the outlet line to an external line for receiving the liquid substance; puncturing the sterilized septum with the piercing member by manually pushing one of the sterilized vial and the piercing member against the other one of the sterilized vial and the piercing member from an exterior of the sterilized pouch without breaching the sterilized pouch, thereby aseptically establishing fluidic communication between the sterilized vial and the outlet line; and pumping the liquid substance from the sterilized vial disposed in an inverted orientation to the external line using an external pump.

According to yet still another aspect of the present invention, a method having features of the present invention for aseptically transferring a liquid substance comprises the steps of providing a transfer system including: a sterilized vial filled with the liquid substance and sealed with a sterilized septum; a sterilized fluidic assembly comprising: a piercing member including therein first and second channels and having a tip end that operably punctures the sterilized septum, the first and second channels having first and second tip openings at the tip end of the piercing member; an inlet line fluidically connected to the first channel of the piercing member; an in-line gas or air filter inserted in or fluidically connected to the inlet line for filtering air flowing through the inlet line; and an outlet line fluidically connected to the second channel of the piercing member at one end and sealed close at the other end; and a sterilized pouch enclosing the sterilized vial and the piercing member; aseptically connecting the outlet line to an external line for receiving the liquid substance; puncturing the sterilized septum with the piercing member by manually pushing one of the sterilized vial and the piercing member against the other one of the sterilized vial and the piercing member from an exterior of the sterilized pouch without breaching the sterilized pouch, thereby aseptically establishing fluidic communication between the sterilized vial and the outlet line; fluidically connecting an external air pump to the inlet line to enable fluidic communication between the external air pump and the first channel; and expelling air from the external air pump into the sterilized vial disposed in an inverted orientation to propel the liquid substance in the sterilized vial through the outlet line and into the external line.

### BRIEF DESCRIPTION OF DRAWINGS

These and other features, aspects, and advantages of the present invention will become better understood with regard to the following description, appended claims, and accompanying drawings where:

FIG. 1 illustrates a system for aseptically transferring a liquid substance from a sterilized vial to a receiving container in accordance with an embodiment of the present invention;

FIG. 2 is a flow diagram illustrating selected steps for fabricating the system of FIG. 1 for aseptically transferring a liquid substance in accordance with an embodiment of the present invention;

FIG. 3 illustrates operation of the system of FIG. 1 for aseptically transferring a liquid substance from a sterilized vial to a receiving container in accordance with an embodiment of the present invention;

FIG. 4 is a flow diagram illustrating selected steps for operating the system of FIG. 1 for aseptically transferring a liquid substance in accordance with an embodiment of the present invention;

FIG. 5 is a perspective view of an exemplary system for aseptically transferring two liquid substances from a pair of sterilized vials to a receiving container in accordance with the embodiment shown in FIG. 1;

FIG. 6 is a cross-sectional view of the piercing members of the exemplary system shown in FIG. 5;

FIG. 7 is a perspective view of the components of the system shown in FIG. 5 enclosed by the sterilized pouch;

FIG. 8 is a perspective view of another exemplary system for aseptically transferring two liquid substances from a pair of sterilized vials to a receiving container in accordance with the embodiment shown in FIG. 1;

FIG. 9 is a perspective view of the components of the system shown in FIG. 8 enclosed by the sterilized pouch;

FIG. 10 is a perspective view of still another exemplary system for aseptically transferring two liquid substances from a pair of sterilized vials to a receiving container in accordance with the embodiment shown in FIG. 1;

FIG. 11 is a perspective view of the components of the system shown in FIG. 10 enclosed by the sterilized pouch;

FIGS. 12A and 12B are section views illustrating operation of the holder of FIG. 11 for puncturing the septa;

FIG. 13 illustrates a system for aseptically transferring a liquid substance from a sterilized vial to a receiving container in accordance with another embodiment of the present invention;

FIG. 14 illustrates a system for aseptically transferring a liquid substance from a sterilized vial to a receiving container in accordance with still another embodiment of the present invention;

FIG. 15 is a flow diagram illustrating selected steps for fabricating the system of FIG. 13 for aseptically transferring a liquid substance in accordance with an embodiment of the present invention;

FIG. 16 illustrates operation of the system of FIG. 13 for aseptically transferring a liquid substance from a sterilized vial to a receiving container in accordance with an embodiment of the present invention;

FIG. 17 is a flow diagram illustrating selected steps for operating the system of FIG. 13 for aseptically transferring a liquid substance in accordance with an embodiment of the present invention;

FIG. 18 illustrates operation of the system of FIG. 13 for aseptically transferring a liquid substance from a sterilized vial to a receiving container in accordance with another embodiment of the present invention;

FIG. 19 is a flow diagram illustrating selected steps for operating the system of FIG. 13 for aseptically transferring a liquid substance in accordance with another embodiment of the present invention;

FIG. 20 illustrates operation of the system of FIG. 14 for aseptically transferring a liquid substance from a sterilized vial to a receiving container in accordance with an embodiment of the present invention;

FIG. 21 is a flow diagram illustrating selected steps for operating the system of FIG. 14 for aseptically transferring a liquid substance in accordance with an embodiment of the present invention;

FIG. 22 illustrates operation of the system of FIG. 14 for aseptically transferring a liquid substance from a sterilized vial to a receiving container in accordance with another embodiment of the present invention;

FIG. 23 is a flow diagram illustrating selected steps for operating the system of FIG. 14 for aseptically transferring a liquid substance in accordance with another embodiment of the present invention;

FIG. 24 is a perspective view of an exemplary system for aseptically transferring a liquid substance from a sterilized vial to a receiving container in accordance with the embodiment shown in FIG. 13;

FIG. 25 is a cross-sectional view of the piercing member of the exemplary system shown in FIG. 24;

FIG. 26 is a perspective view of the components of the system shown in FIG. 24 enclosed by the sterilized pouch;

FIG. 27 is a perspective view of an exemplary system for aseptically transferring a liquid substance from a sterilized vial to a receiving container in accordance with the embodiment shown in FIG. 14;

FIG. 28 is a cross-sectional view of the piercing member of the exemplary system shown in FIG. 27;

FIG. 29 is a perspective view of the components of the system shown in FIG. 27 enclosed by the sterilized pouch;

FIG. 30 illustrates operation of the system of FIG. 1 for aseptically transferring a liquid substance from a sterilized vial to a receiving container in accordance with another embodiment of the present invention; and

FIG. 31 is a flow diagram illustrating selected steps for operating the system of FIG. 1 for aseptically transferring a liquid substance in accordance with another embodiment of the present invention.

For purposes of clarity and brevity, like elements and components will bear the same designations and numbering throughout the Figures, which are not necessarily drawn to scale.

### DETAILED DESCRIPTION OF THE INVENTION

In the Summary above and in the Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously, except where the context excludes that possibility, and the method can include one or more other steps which are carried out before any of the defined steps, between two of the defined steps, or after all the defined steps, except where the context excludes that possibility.

The term “biological objects” as used herein includes cells, bacteria, viruses, molecules, particles including RNA and DNA, cell cluster, bacteria cluster, molecule cluster, and particle cluster.

The term “biological sample” as used herein includes blood, body fluid, tissue extracted from any part of the body, bone marrow, hair, nail, bone, tooth, liquid and solid from bodily discharge, or surface swab from any part of body. “Fluid sample,” or “sample fluid,” or “liquid sample,” or “sample solution” may include a biological sample in its original liquid form, biological objects being dissolved or dispersed in a buffer fluid, or a biological sample dissociated from its original non-liquid form and dispersed in a buffer fluid. A buffer fluid is a liquid into which biological objects may be dissolved or dispersed without introducing contaminants or unwanted biological objects. Biological objects and biological sample may be obtained from human or animal. Biological objects may also be obtained from plants and the environment including air, water, and soil. A fluid sample may contain various types of magnetic or optical labels, or one or more chemical reagents that may be added during various process steps.

The term “sample flow rate” or “flow rate” is used herein to describe the volume amount of a fluid flowing through a cross section of a channel, a conduit, a fluidic part, a fluidic path, or a fluidic line in a unit time.

The term “at least” followed by a number is used herein to denote the start of a range beginning with that number, which may be a range having an upper limit or no upper limit, depending on the variable being defined. For example, “at least 1” means 1 or more than 1. The term “at most” followed by a number is used herein to denote the end of a range ending with that number, which may be a range having 1 or 0 as its lower limit, or a range having no lower limit, depending upon the variable being defined. For example, “at most 4” means 4 or less than 4, and “at most 40%” means 40% or less than 40%. When, in this specification, a range is given as “a first number to a second number” or “a first number-a second number,” this means a range whose lower limit is the first number and whose upper limit is the second number. For example, “25 to 100 nm” means a range whose lower limit is 25 nm and whose upper limit is 100 nm.

Directional terms, such as “front,” “back,” “top,” “bottom,” and the like, may be used with reference to the orientation of the illustrated figure. Spatially relative terms, such as “beneath,” “below,” “under,” “lower,” “upper,” “above,” etc., may be used herein to describe one element's relationship to another element(s) as illustrated in the figure. Since articles and elements can be positioned in a number of different orientations, these terms are intended for illustration purposes and in no way limit the invention, except where the context excludes that possibility.

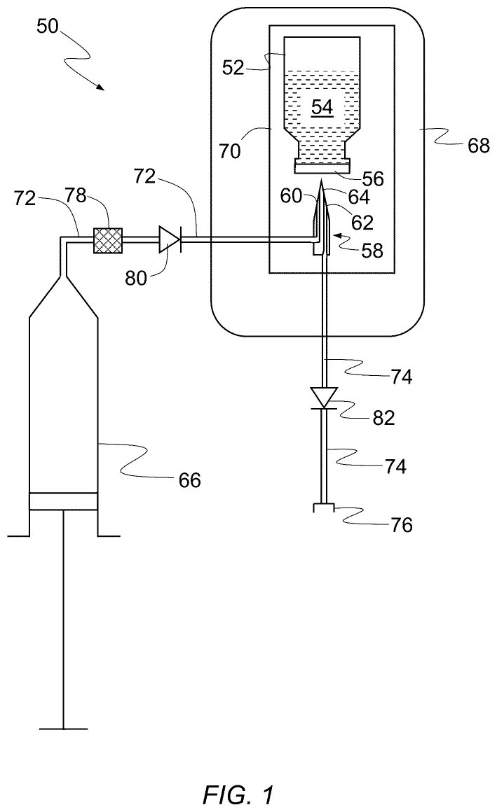

FIG. 1 illustrates a system for aseptically transferring a liquid substance from a vial to a receiving container in accordance with an embodiment of the present invention. The system 50 comprises a sterilized vial 52 aseptically filled with a liquid substance 54 and sealed with a sterilized septum 56 at its mouth, a sterilized fluidic assembly that includes a piercing member 58 including therein first and second lumens or channels 60, 62 and having a tip end 64 that can operably pierce the sterilized septum 56 to establish fluidic communications between the chamber of the sterilized vial 52 and the first and second channels 60, 62, a manual air pump 66 for pumping air into the sterilized vial 52, an inlet line 72 that fluidically connects the manual air pump 66 to the first channel 60 of the piercing member 58, and an outlet line 74 connected to the second channel 62 of the piercing member 58 at one end and sealed close at the other end, and a sterilized pliable container 68 enclosing the sterilized vial 52 and the piercing member 58 and operably allowing the piercing member 58 to puncture through the sterilized septum 56 without breaching the sterilized pliable container 68 when one of the sterilized vial 52 and the piercing member 58 is manually pushed against the other one of the sterilized vial 52 and the piercing member 58 from the exterior of the sterilized pliable container 68.

The first and second channels 60, 62 have first and second tip openings at the tip end 64 of the piercing member 58, respectively. The other ends the first and second channels 60, 62 are connected to the inlet and outlet lines 72, 74, respectively. When the piercing member 58 punctures through the septum 56 at the time of use, the first and second tip openings at the tip end 64 will be exposed to the interior or chamber of the sterilized vial 52, thereby fluidically connecting the interior or chamber of the sterilized vial 52 to the outlet line 74 and the manual air pump 66 through the inlet line 72.

The system 50 may further comprise a sterilized holder 70, onto which the sterilized vial 52 and the piercing member 58 are mounted. The sterilized holder 70, together with the sterilized vial 52 and the piercing member 58, may be sealed in or enclosed by the sterilized pliable container 68 and may provide a guiding means or mechanism for the piercing member 58 to puncture the sterilized septum 56 in the sterilized pliable container 68 without breaching the sterilized pliable container 68 when one of the sterilized vial 52 and the piercing member 58 is manually pushed against the other one of the sterilized vial 52 and the piercing member 58 from the exterior of the sterilized pliable container 68.

The fluidic assembly of the system 50 may further comprise an air filter 78 inserted in or fluidically connected to the inlet line 72 for filtering the air discharged from the manual air pump 66, thereby preserving the sterility of air entering the sterilized vial 52, and/or an optional check valve 80 inserted in or fluidically connected to the inlet line 72 to prevent the backflow of air to the manual air pump 66, and/or another optional check valve 82 inserted in or fluidically connected to the outlet line 74 to prevent backflow of the liquid substance 54 to the sterilized vial 52 during the transfer operation, and/or additional connectors inserted in or fluidically connected to the inlet and outlet lines 72, 74.

The sterilized vial 52 may be made of glass and sealed by the sterilized septum 56 comprising an elastomeric material, such as but not limited to polytetrafluoroethylene (PTFE) or PTFE/silicone/PTFE laminates. The sterilized septum 56 may be held in place by a retainer (not shown) extending around the neck of the sterilized vial 52, and particularly around a collar or flange formed on the neck of the sterilized vial 52. The retainer may also extend partially over the exterior surface of the sterilized septum 56 to leave an exposed region of the sterilized septum 56 for access to the interior or chamber of the sterilized vial 52 with the piercing member 58. The sterilized vial 52 itself without the liquid substance 54 therein and the sterilized septum 56 may be sterilized by any suitable sterilization method, such as but not limited to steam sterilization, chemical sterilization, e-beam sterilization, or gamma ray radiation sterilization, prior to filling the sterilized vial 52 with the liquid substance 54 under an aseptic or sterile condition to prevent potential contamination.

The liquid substance 54 may comprise any substance or ingredient used in manufacturing of biologics, such as but not limited to water, buffer, cell culture media, serum, freeze media, transduction enhancer (e.g., peptide, polymer), protein (e.g., IL2, IL-15, or antibody), magnetic beads-antibody conjugates for cell sorting (i.e., magnetic labels), lipid nanoparticles, plasmids, virus, cells, extravascular suspension, or any combination thereof.

The piercing member 58 of the sterilized fluidic assembly may be made of a metallic, ceramic, or polymeric material that is sufficiently hard for puncturing through the elastomeric septum 56. For example and without limitation, the piercing member 58 may be made of stainless steel. The inlet line 72 and outlet line 74 of the sterilized fluidic assembly may be made of a pliable/flexible thermoplastic material, such as but not limited to polyvinyl chloride (PVC). The free end of the outlet line 74 may be hermetically sealed by heat-induced welding. Prior to transferring the liquid substance 54 out of the sterilized vial 52, the free end of the outlet line 74 may be aseptically welded to another line connected to a receiving container (not shown), thereby aseptically transferring the liquid substance 54 to the receiving container. Alternatively, the free end of the outlet line 74 may be terminated by a male or female half of an aseptic connector 76, which is then connected to the opposite half of the aseptic connector attached to another line at the time of use. The male and female halves of the aseptic connector 76 each contain a sterile membrane, which is removed when the male and female halves are joined together, thereby forming a closed and sterile fluid path between the lines at the opposite ends of the aseptic connector 76.

The manual air pump 66 of the fluidic assembly may be in the form of a syringe, which includes a barrel and a plunger, or any air bladder device filled with sufficient air to propel substantially all of the liquid substance 54 out of the sterilized vial 52. The syringe or air bladder device may be manually squeezed by hand to push the air therein into the sterilized vial 52, thereby propelling the liquid substance 54 into the outlet line 74. The manual air pump 66 may alternatively be replaced by a portable air pump powered by battery or electricity to inject air into the sterilized vial 52.

The sterilized fluidic assembly, which includes the piercing member 58, the inlet line 72, the manual air pump 66, the outlet line 74, the optional air filter 78, and the optional check valves 80, 82 may be sterilized by heat, steam, gamma ray radiation, or other suitable means.

The sterilized pliable container 68 may be in the form of a bag or pouch and is sufficiently supple and resilient to allow the piercing member 58 to puncture the septum 56 by manual manipulation from outside of the sterilized pliable container 68 without breaking or tearing the sterilized pliable container 68, thereby ensuring the interior of the sterilized pliable container 68 and all fluidic paths in the sterilized fluidic assembly remain sterile after establishing fluidic communication between the sterilized vial 52 and the inlet and outlet lines 72, 74. The sterilized pliable container 68 in the form of bag or pouch may be made of any suitable polymeric material, such as but not limited to PVC, and may be sterilized by ethylene oxide, alcohol, gamma ray radiation, or other suitable methods. The sterilized pliable container 68 may enclose at least the sterilized vial 52, the piercing member 58, segments of the inlet and outlet lines 72, 74 connected to the piercing member 58, and the sterilized holder 70, if any. If the piercing member 58 is designed to be pushed against the sterilized vial 52 at the time of use, then there may be some slack in the inlet and outlet lines 72, 74 inside the sterilized pliable container 68 to accommodate the movement of the piercing member 58. Other fluidic components, such as but not limited to the manual air pump 66, the optional air filter 78, and the optional check valves 80, 82, may also be sealed within or enclosed by the sterilized pliable container 68. The free end of the outlet line 74, which is welded close or terminated with a male or female half of the aseptic connector 76, will be aseptically connected to an external line at the time of use and therefore should not be sealed in the sterilized pliable container 68. The sterilized vial 52, the piercing member 58 of the sterilized fluidic assembly, and the sterilized holder 70, onto which the sterilized vial 52 and the piercing member 58 are separately mounted, may be sealed in or enclosed by the sterilized pliable container 68 in an aseptic or sterile environment to preserve the sterility of the components enclosed therein. The system 50 may be discarded after the liquid substance 54 is transferred from the sterilized vial 52 to the receiving container (i.e. single-use application).

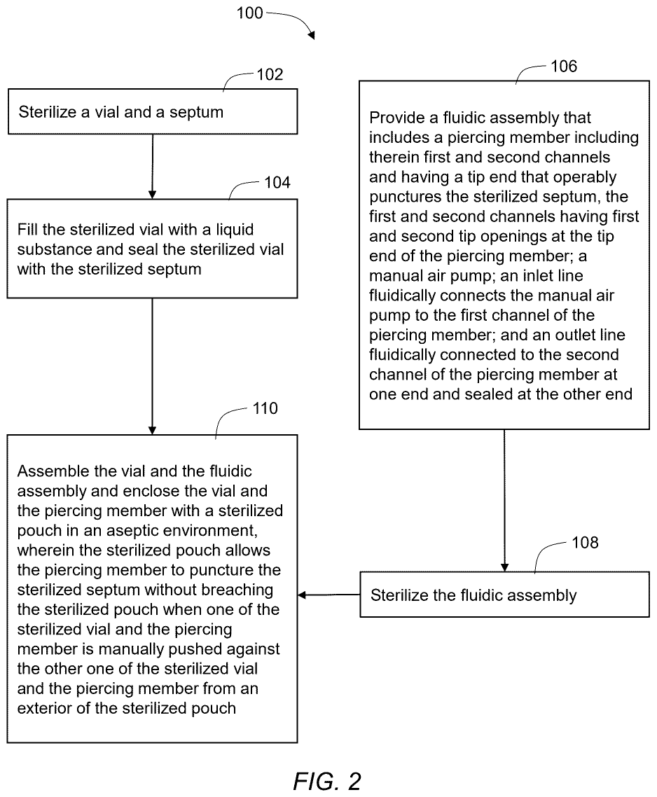

Manufacturing of the system 50 will now be described with reference to FIG. 1 and the flow diagram of FIG. 2, which illustrates selected steps 100 for fabricating the system 50 for aseptically transferring a liquid substance in accordance with an embodiment of the present invention. The process begins at step 102 by sterilizing a vial 52 and a septum 56. After sterilizing the vial 52 and the septum 56, the sterilized vial 52 is aseptically filled with the liquid substance 54 and sealed with the sterilized vial 56 in an aseptic or sterile environment at step 104.

At step 106, a fluidic assembly is provided that includes a piercing member 58 including therein first and second channels 60, 62 and having a tip end 64 that can operably puncture through the sterilized septum 56, the first and second channels having first and second tip openings at the tip end 64 of the piercing member 58; a manual air pump 66; an inlet line 72 that fluidically connects the manual air pump 66 to the first channel 60 of the piercing member 58; and an outlet line 74 fluidically connected to the second channel 62 of the piercing member 58 at one end and sealed close at the other end, as described above with reference to FIG. 1. The fluidic assembly may further include an air filter 78 inserted in or fluidically connected to the inlet line 72 for filtering the air discharged from the manual air pump 66, and/or an optional check valve 80 inserted in or fluidically connected to the inlet line 72 to prevent the backflow of air to the manual air pump 66, and/or another optional check valve 82 inserted in or fluidically connected to the outlet line 74 to prevent backflow of the liquid substance 54 to the sterilized vial 52 during the transfer operation, and/or any additional connectors inserted in or fluidically connected to the inlet and outlet lines 72, 74. In an embodiment, the manual air pump 66 is a syringe.

After providing the fluidic assembly, the fluidic assembly is sterilized by a suitable means, such as but not limited to heat, steam, or gamma ray radiation, at step 108.

Since the sterilization of the vial 52 is independent of the sterilization of the fluidic assembly, steps 102/104 and steps 106/108 can be carried out in the reversed order (i.e., steps 106/108 and then steps 102/104) or simultaneously.

Next, at step 110, the sterilized vial 52 and the sterilized fluidic assembly are assembled, and the sterilized vial 52 and the piercing member 58 are sealed in or enclosed by a sterilized pouch 68 in an aseptic or sterile environment. The sterilized pouch 68 allows the piercing member 58 to puncture the sterilized septum 56 without breaching the sterilized pouch 68 when one of the sterilized vial 52 and the piercing member 58 is manually pushed against the other one of the sterilized vial 52 and the piercing member 58 from the exterior of the sterilized pouch 68.

The sterilized vial 52 and the piercing member 58 may be separately mounted on a sterilized holder 70 that provides a guiding mechanism for the piercing member 58 to puncture the sterilized septum 56 of the sterilized vial 52 in the sterilized pouch 68. The sterilized holder 70, together with the sterilized vial 52 and the piercing member 58, may be sealed in or enclosed by the sterilized pouch 68 at step 110.

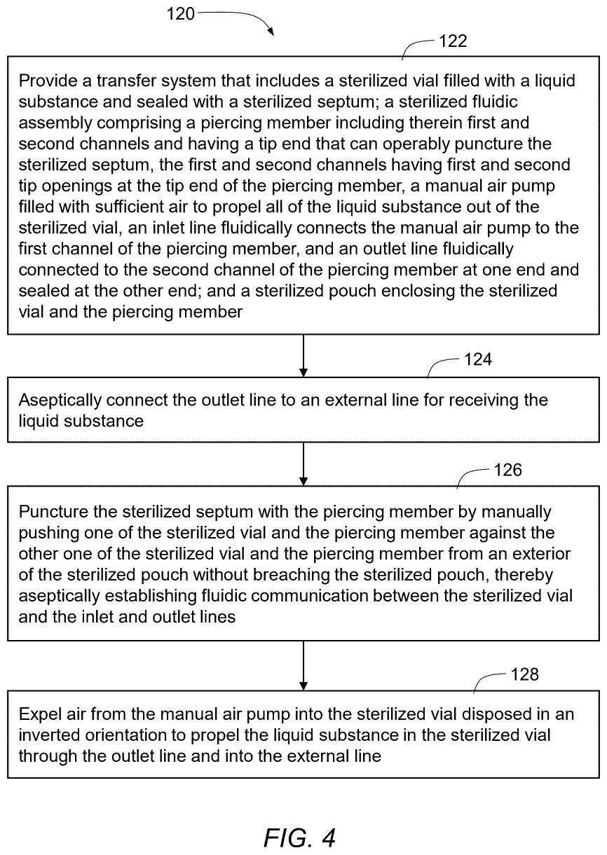

Operation of the system 50 will now be described with reference to FIGS. 1, 3, and 4. The flow diagram of FIG. 4 illustrates selected steps 120 for using the system 50 to aseptically transfer a liquid substance from a vial in accordance with an embodiment of the present invention. The process begins at step 122 by providing a transfer system 50 that includes a sterilized vial 52 filled with a liquid substance 54 and sealed with a sterilized septum 56; a sterilized fluidic assembly comprising a piercing member 58 including therein first and second channels 60, 62 and having a tip end 64 that can operably puncture through the sterilized septum 56, the first and second channels 60, 62 having first and second tip openings at the tip end 64 of the piercing member 58, a manual air pump 66 filled with sufficient air to propel all of the liquid substance 54 out of the sterilized vial 52, an inlet line 72 that fluidically connects the manual air pump 66 to the first channel 60 of the piercing member 58, and an outlet line 74 fluidically connected to the second channel 62 of the piercing member 58 at one end and sealed close at the other end; and a sterilized pouch 68 enclosing the sterilized vial 52 and the piercing member 58. In an embodiment, the manual air pump 66 is a syringe.

The system 50 may further include a sterilized holder 70. The sterilized vial 52 and the piercing member 58 may be separately mounted on a sterilized holder 70 that provides a guiding mechanism for the piercing member 58 to puncture the sterilized septum 56 of the sterilized vial 52 in the sterilized pouch 68. The sterilized holder 70, together with the sterilized vial 52 and the piercing member 58, may be sealed in or enclosed by the sterilized pouch 68. The sterilized holder 70 may be made of any moldable material that has sufficient mechanical rigidity and can withstand the sterilization process, such as but not limited to thermoplastic materials.

Next, at step 124, the outlet line 74 is aseptically connected to an external line 84 for receiving the liquid substance 54. The other end of the external line 84 may be connected to a receiving container (not shown). For the outlet line 74 sealed by thermal welding, this may be carried out by using a commercial tube welder that maintains the sterility of the connection. For the outlet line 74 that uses an aseptic connector, this may be carried out by connecting the male or female half of the aseptic connector 76 attached to the free end of the outlet line 74 to the opposite half of the aseptic connector 76 attached to the external line 84.

At step 126, the sterilized septum 56 is punctured with the piercing member 58 by manually pushing one of the sterilized vial 52 and the piercing member 58 against the other one of the sterilized vial 52 and the piercing member 58 from an exterior of the sterilized pouch 68 without breaching the sterilized pouch 68, thereby aseptically establishing fluidic communications between the sterilized vial 52 and the inlet and outlet lines 72, 74. Steps 124 and 126 may be carried out in the reversed order or simultaneously.

After steps 124 and 126, the manual air pump 66 pushes air into the sterilized vial 52 oriented in an inverted position (i.e., the tip opening of the second channel 62 of the piercing member 58 is submerged in the liquid substance 54) to propel the liquid substance 54 in the sterilized vial 52 through the outlet line 74 and the external line 84 and into the receiving container at step 128. If only a portion of the liquid substance 54 in the sterilized vial 52 needs to be transferred to the receiving container, the sterilized vial 52 may be reoriented in an upright position (i.e., the tip opening of the second channel 62 of the piercing member 58 is not covered by the liquid substance 54) after the portion of the liquid substance 54 has been transferred out of the sterilized vial 52. After the sterilized vial 52 is reoriented in the upright position, the manual air pump 66 may continue to inject air into the sterilized vial 52, thereby pushing the residual liquid substance 54 remaining in the outlet line 74 and the external line 84 into the receiving container without further draining the liquid substance 54 remaining in the sterilized vial 52. In an embodiment, the manual air pump 66 is a syringe.

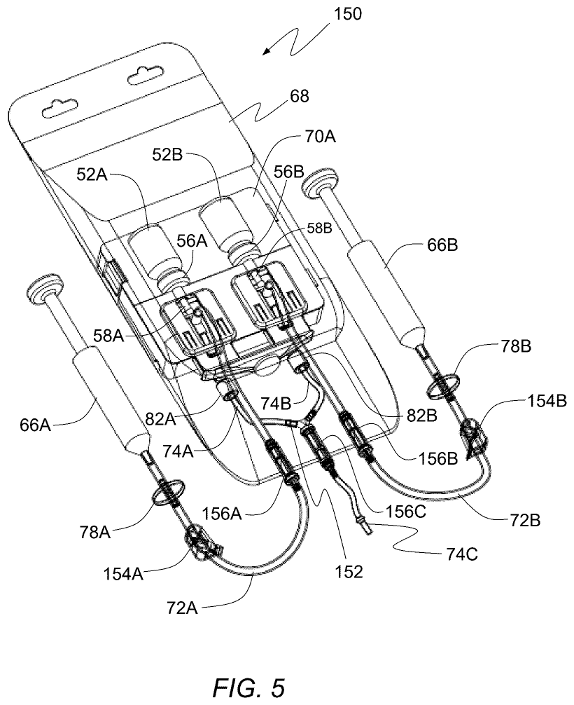

The following examples are provided to illustrate, but not limit the invention. FIG. 5 is a perspective view of an exemplary system 150 for aseptically transferring up to two fluid substances from two vials in accordance with an embodiment of the present invention. The system 150 comprises a pair of sterilized vials 52A, 52B filled with respective liquid substances and sealed with sterilized septa 56A, 56B, a sterilized fluidic assembly, a sterilized holder 70A, and a sterilized pouch 68.

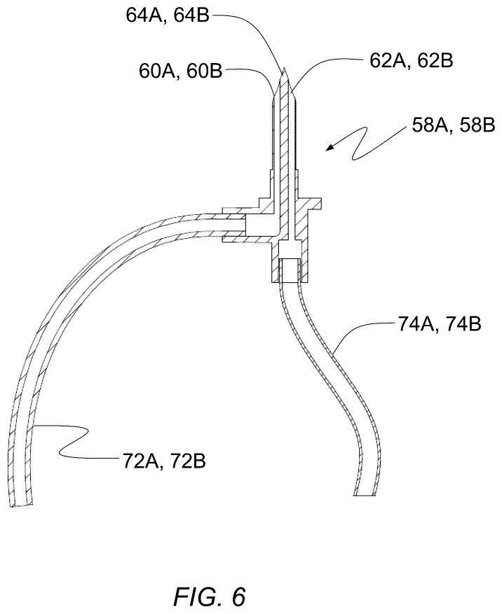

The sterilized fluidic assembly comprises a pair of piercing members 58A, 58B, each of which includes therein a first channel 60A, 60B and a second channel 62A, 62B and having a tip end 64A, 64B that can operably puncture through the sterilized septum 56A, 56B, as shown in FIG. 6. The first channel 60A, 60B and the second channel 62A, 62B have the first and second tip openings at the tip end 64A, 64B of the piercing member 58A, 58B.

Referring back to FIG. 5, the sterilized fluidic assembly further comprises a pair of manual air pumps 66A, 66B in the form of syringes, a pair of inlet lines 72A, 72B that connect the syringes 66A, 66B to the piercing members 58A, 58B through a pair of pass-through connectors 156A, 156B, and a pair of outlet lines 74A, 74B fluidically connected to the second channels of the piercing member 58A, 58B at one end and an integrated outlet line 74C at the other end through a three-way connector 152 and a pass-through connector 156C. The free end of the integrated outlet line 74C may be hermetically sealed by heat-induced welding. The inlet lines 72A, 72B include in-line air filters 78A, 78B for filtering air expelled from the syringes 66A, 66B and clamps or pinch valves 154A, 154B for regulating the air flow through the inlet lines 72A, 72B. The outlet lines 74A, 74B include check valves 82A, 82B that prevent the backflow of liquid substances.

The sterilized vials 52A, 52B, the sterilized holder 70A, and a part of the sterilized fluidic assembly including the piercing members 58A, 58B, the outlet lines 74A, 74B connected thereto, the check valves 82A, 82B, the three-way connector 152 connected to the outlet lines 74A, 74B, and segments of the inlet lines 72A, 72B are enclosed by the sterilized pouch 68 to preserve sterility. The inlet lines 72A, 72B fluidically connect the syringes 66A, 66B disposed outside the sterilized pouch 68 to the piercing members 58A, 58B disposed inside the sterilized pouch 68 via the pass-through connectors 156A, 156B. The three-way connector 152 disposed inside the sterilized pouch 68 is connected to one end of the pass-through connector 156C, the other end of which is connected to the integrated outlet line 74C disposed outside the sterilized pouch 68. The pass-through connectors 156A-156C may extend through the sealed sterilized pouch 68 along a seam thereof.

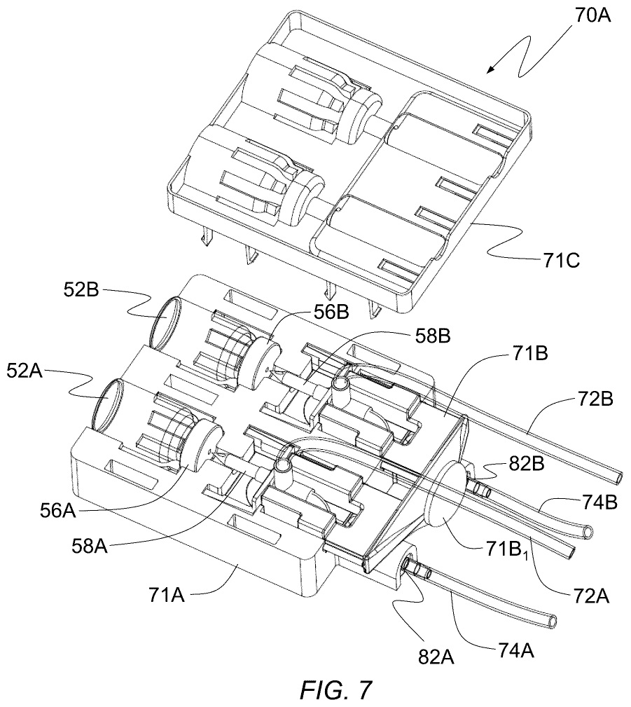

FIG. 7 is a perspective view of the portion of the exemplary system 150 that is sealed in or enclosed by the sterilized pouch 68, including the sterilized holder 70A, which comprises a base 71A, a press structure 71B that is fitted into first pair of slots at one end of the base 71A, and a cover 71C, the piercing members 58A, 58B attached to the press structure 71B and disposed in the first two slots, the inlet and outlet lines 72A, 72B, 74A, 74B connected to the piercing members 58A, 58B, the check valves 82A, 82B, and the sterilized vials 52A, 52B fitted into a second pair of slots at the opposite end of the base 71A, with the sterilized septa 56A, 56B aligned to the piercing members 58A, 58B, respectively. The cover 71C of the sterilized holder 70A may be attached to the base 71A of the sterilized holder 70A to secure the sterilized vials 52A, 52B, the press structure 71B, and the piercing members 58A, 58B between the base 71A and cover 71C. At the time of use, a knob structure 71B₁ at one end of the press structure 71B may be manually pushed towards the sterilized vials 52A, 52B from outside of the sterilized pouch 68, thereby puncturing through the sterilized septa 56A, 56B by the piercing members 58A, 58B and establishing fluidic communications between the sterilized vials 52A, 52B and the inlet and outlet lines 72A, 72B, 74A, 74B.

Operation of the system 150 for aseptically transferring the liquid substances in the sterilized vials 52A, 52B to a receiving container will now be described with reference to FIGS. 5 and 7. The free end of the integrated outlet line 74C may be aseptically connected to another line fluidically connected to the receiving container (not shown) by a commercial tube welder. The press structure 71B may be manually pushed towards the sterilized vials 52A, 52B from outside of the sterilized pouch 68 to puncture through the sterilized septa 56A, 56B by the piercing members 58A, 58B, thereby establishing aseptic fluidic communications between the sterilized vials 52A, 52B and the inlet and outlet lines 72A, 72B, 74A, 74B, 74C. With the sterilized vials 52A, 52B hung upside down and the pinch valve 154A released, the plunger of the syringe 66A is pushed to inject air through the inlet line 72A into the sterilized vial 52A, thereby pushing the liquid substance therein through the outlet line 74A and the integrated outlet line 74C and into the receiving container. Similarly, the liquid substance in the vial 52B flows through the outlet line 74B and the integrated outlet line 74C and into the receiving container in response to air injected from the syringe 66B into the sterilized vial 52B.

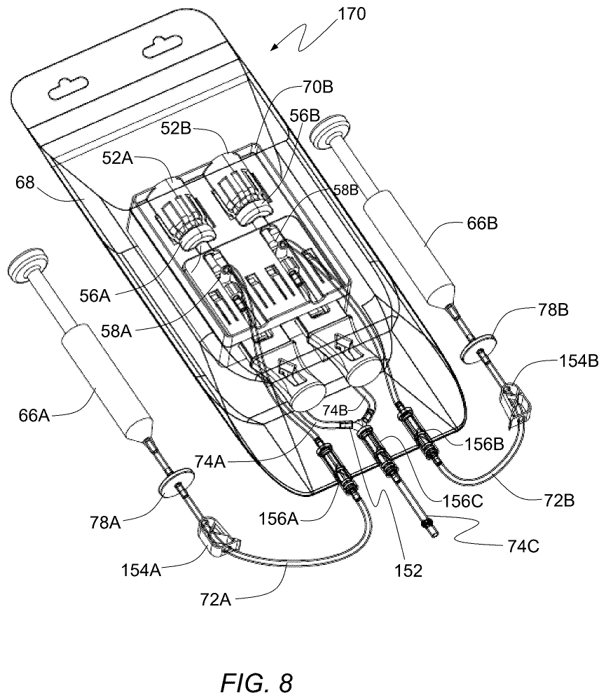

FIG. 8 is a perspective view of another exemplary system 170 for aseptically transferring up to two fluid substances from two vials in accordance with an embodiment of the present invention. The system 170 comprises a pair of sterilized vials 52A, 52B filled with respective liquid substances and sealed with sterilized septa 56A, 56B, a sterilized fluidic assembly, a sterilized holder 70B, and a sterilized pouch 68. The system 170 differs from the system 150 of FIG. 5 in that the holder 70B allows the piercing members 58A, 58B to be independently actuated.

The sterilized fluidic assembly comprises a pair of piercing members 58A, 58B, each of which includes therein a first channel 60A, 60B and a second channel 62A, 62B and having a tip end 64A, 64B that can operably puncture through the sterilized septum 56A, 56B, as shown in FIG. 6. The first channel 60A, 60B and the second channel 62A, 62B have the first and second tip openings at the tip end 64A, 64B of the piercing member 58A, 58B.

Referring back to FIG. 8, the sterilized fluidic assembly further comprises a pair of manual air pumps 66A, 66B in the form of syringes, a pair of inlet lines 72A, 72B that connect the syringes 66A, 66B to the piercing members 58A, 58B through a pair of pass-through connectors 156A, 156B, and a pair of outlet lines 74A, 74B fluidically connected to the second channels of the piercing member 58A, 58B at one end and an integrated outlet line 74C at the other end through a three-way connector 152 and a pass-through connector 156C. The free end of the integrated outlet line 74C may be hermetically sealed by heat-induced welding. The inlet lines 72A, 72B include in-line air filters 78A, 78B for filtering air expelled from the syringes 66A, 66B and clamps or pinch valves 154A, 154B for regulating the air flow through the inlet lines 72A, 72B. The outlet lines 74A, 74B optionally include check valves 82A, 82B that prevent the backflow of liquid substances.

The sterilized vials 52A, 52B, the sterilized holder 70B, and a part of the sterilized fluidic assembly including the piercing members 58A, 58B, the outlet lines 74A, 74B connected thereto, the check valves 82A, 82B, the three-way connector 152 connected to the outlet lines 74A, 74B, and segments of the inlet lines 72A, 72B are enclosed by the sterilized pouch 68 to preserve sterility. The inlet lines 72A, 72B fluidically connect the syringes 66A, 66B disposed outside the sterilized pouch 68 to the piercing members 58A, 58B disposed inside the sterilized pouch 68 via the pass-through connectors 156A, 156B. The three-way connector 152 disposed inside the sterilized pouch 68 is connected to one end of the pass-through connector 156C, the other end of which is connected to the integrated outlet line 74C disposed outside the sterilized pouch 68. The pass-through connectors 156A-156C may extend through the sealed sterilized pouch 68 along a seam thereof.

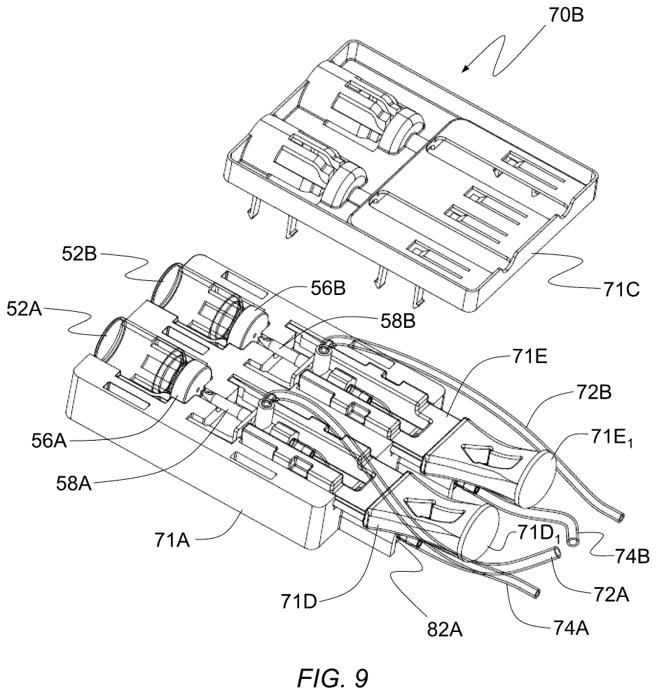

FIG. 9 is a perspective view of the portion of the exemplary system 170 that is sealed in or enclosed by the sterilized pouch 68, including the sterilized holder 70B, which comprises a base 71A, first and second press structures 71D, 71E that are fitted into a first pair of slots at one end of the base 71A, and a cover 71C, the piercing members 58A, 58B attached to the press structures 71D, 71E and disposed in the first two slots, the inlet and outlet lines 72A, 72B, 74A, 74B connected to the piercing members 58A, 58B, the check valves 82A, 82B, and the sterilized vials 52A, 52B fitted into second pair of slots at the opposite end of the base 71A, with the sterilized septa 56A, 56B aligned to the piercing members 58A, 58B, respectively. The cover 71C of the sterilized holder 70B may be attached to the base 71A of the sterilized holder 70B to secure the sterilized vials 52A, 52B, the press structures 71D, 71E, and the piercing members 58A, 58B between the base 71A and cover 71C. At the time of use, a knob structure 71D₁ at one end of the first press structure 71D may be manually pushed towards the sterilized vial 52A from outside of the sterilized pouch 68, thereby puncturing through the sterilized septum 56A by the piercing members 58A and establishing fluidic communications between the sterilized vial 52A and the inlet and outlet lines 72A, 74A. Similarly, another knob structure 71E₁ at one end of the second press structure 71E may be manually pushed towards the sterilized vial 52B from outside of the sterilized pouch 68, thereby puncturing through the sterilized septum 56B by the piercing members 58B and establishing fluidic communications between the sterilized vial 52B and the inlet and outlet lines 72B, 74B. The sterilized holder 70B with two press structures 71D, 71E allows independent actuation of the piercing members 58A, 58B.

Operation of the system 170 for aseptically transferring the liquid substances in the sterilized vials 52A, 52B to a receiving container will now be described with reference to FIGS. 8 and 9. The free end of the integrated outlet line 74C may be aseptically connected to another line fluidically connected to the receiving container (not shown) by a commercial tube welder. The first press structure 71D may be manually pushed towards the sterilized vial 52A from outside of the sterilized pouch 68 to puncture through the sterilized septum 56A by the piercing member 58A, thereby establishing aseptic fluidic communications between the sterilized vial 52A and the inlet and outlet lines 72A, 74A, 74C. With the sterilized vial 52A hung upside down and the pinch valve 154A released, the plunger of the syringe 66A is pushed to inject air through the inlet line 72A into the sterilized vial 52A, thereby pushing the liquid substance therein through the outlet line 74A and the integrated outlet line 74C and into the receiving container. Similarly, the second press structure 71E may be manually pushed towards the sterilized vial 52B from outside of the sterilized pouch 68 to puncture through the sterilized septum 56B by the piercing member 58B, thereby establishing aseptic fluidic communications between the sterilized vial 52B and the inlet and outlet lines 72B, 74B, 74C. With the sterilized vial 52B hung upside down and the pinch valve 154B released, the plunger of the syringe 66B is pushed to inject air through the inlet line 72B into the sterilized vial 52B, thereby pushing the liquid substance therein through the outlet line 74B and the integrated outlet line 74C and into the receiving container.

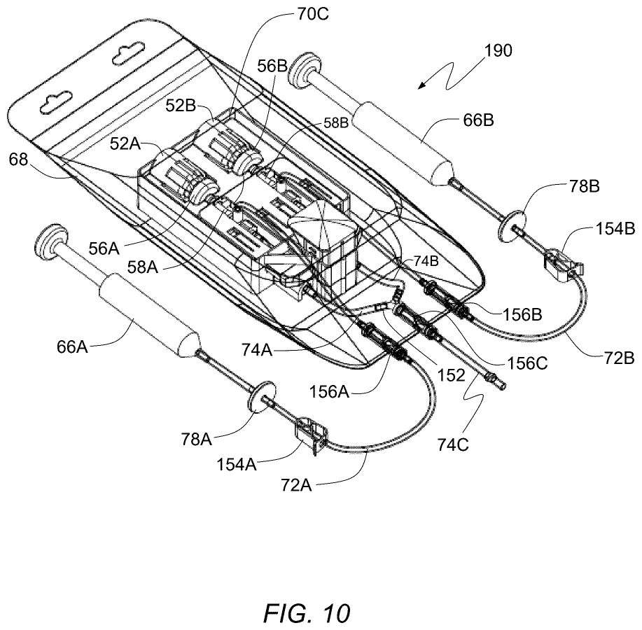

FIG. 10 is a perspective view of still another exemplary system 190 for aseptically transferring up to two fluid substances from two vials in accordance with an embodiment of the present invention. The system 190 comprises a pair of sterilized vials 52A, 52B filled with respective liquid substances and sealed with sterilized septa 56A, 56B, a sterilized fluidic assembly, a sterilized holder 70C, and a sterilized pouch 68. The system 190 differs from the system 150 of FIG. 5 in that the holder 70C has a different mechanism for actuating the piercing members 58A, 58B for puncturing the sterilized septa 56A, 56B.

The sterilized fluidic assembly comprises a pair of piercing members 58A, 58B, each of which includes therein a first channel 60A, 60B and a second channel 62A, 62B and having a tip end 64A, 64B that can operably puncture through the sterilized septum 56A, 56B, as shown in FIG. 6. The first channel 60A, 60B and the second channel 62A, 62B have the first and second tip openings at the tip end 64A, 64B of the piercing member 58A, 58B.

Referring back to FIG. 10, the sterilized fluidic assembly further comprises a pair of manual air pumps 66A, 66B in the form of syringes, a pair of inlet lines 72A, 72B that connect the syringes 66A, 66B to the piercing members 58A, 58B through a pair of pass-through connectors 156A, 156B, and a pair of outlet lines 74A, 74B fluidically connected to the second channels of the piercing member 58A, 58B at one end and an integrated outlet line 74C at the other end through a three-way connector 152 and a pass-through connector 156C. The free end of the integrated outlet line 74C may be hermetically sealed by heat-induced welding. The inlet lines 72A, 72B include in-line air filters 78A, 78B for filtering air expelled from the syringes 66A, 66B and clamps or pinch valves 154A, 154B for regulating the air flow through the inlet lines 72A, 72B. The outlet lines 74A, 74B optionally include check valves 82A, 82B that prevent the backflow of liquid substances.

The sterilized vials 52A, 52B, the sterilized holder 70C, and a part of the sterilized fluidic assembly including the piercing members 58A, 58B, the outlet lines 74A, 74B connected thereto, the check valves 82A, 82B, the three-way connector 152 connected to the outlet lines 74A, 74B, and segments of the inlet lines 72A, 72B are enclosed by the sterilized pouch 68 to preserve sterility. The inlet lines 72A, 72B fluidically connect the syringes 66A, 66B disposed outside the sterilized pouch 68 to the piercing members 58A, 58B disposed inside the sterilized pouch 68 via the pass-through connectors 156A, 156B. The three-way connector 152 disposed inside the sterilized pouch 68 is connected to one end of the pass-through connector 156C, the other end of which is connected to the integrated outlet line 74C disposed outside the sterilized pouch 68. The pass-through connectors 156A-156C may extend through the sealed sterilized pouch 68 along a seam thereof.

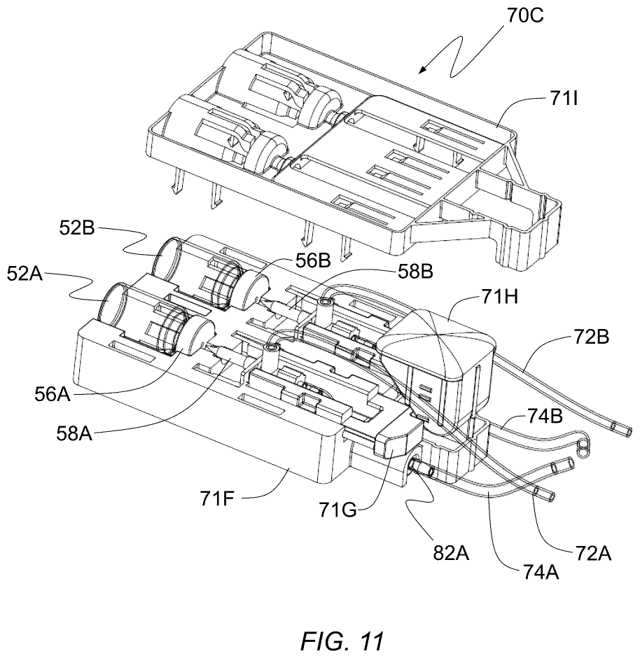

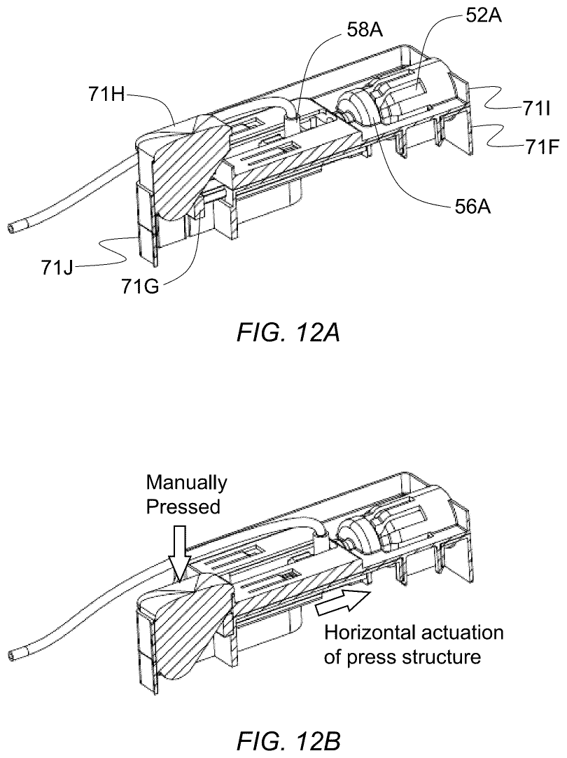

FIG. 11 is a perspective view of the portion of the exemplary system 190 that is sealed in or enclosed by the sterilized pouch 68, including the sterilized holder 70C, which comprises a base 71F, a press structure 71G that is fitted into first pair of slots at one end of the base 71F, a button or knob structure 71H for transmitting force to the press structure 71G, and a cover 71I, the piercing members 58A, 58B attached to the press structure 71G and disposed in the first two slots, the inlet and outlet lines 72A, 72B, 74A, 74B connected to the piercing members 58A, 58B, and the sterilized vials 52A, 52B fitted into second pair of slots at the opposite end of the base 71F, with the sterilized septa 56A, 56B aligned to the piercing members 58A, 58B, respectively. The cover 71I of the sterilized holder 70C may be attached to the base 71F of the sterilized holder 70C to secure the sterilized vials 52A, 52B, the press structure 71G, and the piercing members 58A, 58B between the base 71F and cover 71I. At the time of use, the press structure 71G may be manually pushed towards the sterilized vials 52A, 52B from outside of the sterilized pouch 68, thereby puncturing through the sterilized septa 56A, 56B by the piercing members 58A, 58B and establishing fluidic communications between the sterilized vials 52A, 52B and the inlet and outlet lines 72A, 72B, 74A, 74B. Alternatively, the section views of FIGS. 12A and 12B further show that at the time of use, the knob structure 71H, which has a slanted bottom, may be manually pushed downward into a sleeve 71J that partially surrounds the knob structure 71H, thereby exerting a horizontal force on the press structure 71G and the piercing members 58A, 58B attached thereto for puncturing through the sterilized septa 56A, 56B.

Operation of the system 190 for aseptically transferring the liquid substances in the sterilized vials 52A, 52B to a receiving container will now be described with reference to FIGS. 10-12. The free end of the integrated outlet line 74C may be aseptically connected to another line fluidically connected to the receiving container (not shown) by a commercial tube welder. The press structure 71G may be manually pushed towards the sterilized vials 52A, 52B from outside of the sterilized pouch 68 to puncture through the sterilized septa 56A, 56B by the piercing members 58A, 58B, thereby establishing aseptic fluidic communications between the sterilized vials 52A, 52B and the inlet and outlet lines 72A, 72B, 74A, 74B, 74C. Alternatively, the piercing members 58A, 58B may be actuated to puncture through the sterilized septa 56A, 56B by pushing the knob structure 71H of the holder 70C downward into the sleeve 71J. With the sterilized vials 52A, 52B hung upside down and the pinch valve 154A released, the plunger of the syringe 66A is pushed to inject air through the inlet line 72A into the sterilized vial 52A, thereby pushing the liquid substance therein through the outlet line 74A and the integrated outlet line 74C and into the receiving container. Similarly, the liquid substance in the vial 52B flows through the outlet line 74B and the integrated outlet line 74C and into the receiving container in response to air injected from the syringe 66B into the sterilized vial 52B.

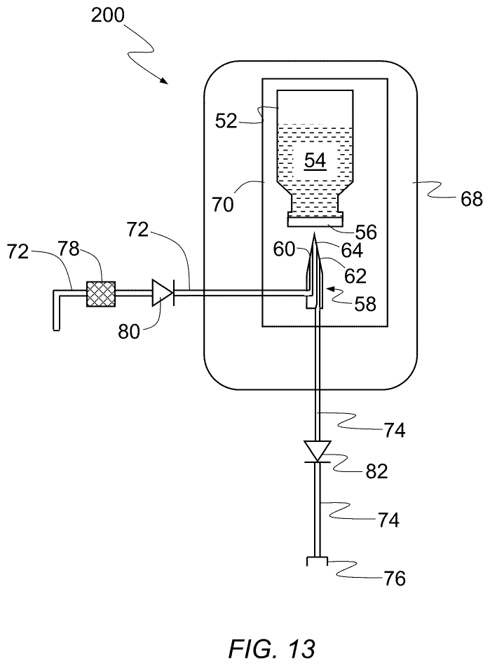

FIG. 13 illustrates another system for aseptically transferring a liquid substance from a vial to a receiving container in accordance with another embodiment of the present invention. In contrast to the system 50 shown in FIG. 1 which includes the manual air pump 66 for pneumatically pushing the liquid substance 54 out of the sterilized vial 52, the current system 200 may rely on an external pump to extract a liquid substance from a sterilized vial at the time of use. The system 200 comprises a sterilized vial 52 aseptically filled with a liquid substance 54 and sealed with a sterilized septum 56 at its mouth, a sterilized fluidic assembly that includes a piercing member 58 including therein first and second lumens or channels 60, 62 and having a tip end 64 that can operably pierce the sterilized septum 56 to establish fluidic communications between the chamber of the sterilized vial 52 and the first and second channels 60, 62, an inlet line 72 fluidically connected to the first channel 60 of the piercing member 58 at one end, an in-line gas or air filter 78 (e.g., 0.22 μm filter) inserted in or fluidically connected to the inlet line 72 for filtering air flowing through the inlet line 72, and an outlet line 74 connected to the second channel 62 of the piercing member 58 at one end and sealed close at the other (free) end, and a sterilized pliable container 68 enclosing the sterilized vial 52 and the piercing member 58 and operably allowing the piercing member 58 to puncture through the sterilized septum 56 without breaching the sterilized pliable container 68 when one of the sterilized vial 52 and the piercing member 58 is manually pushed against the other one of the sterilized vial 52 and the piercing member 58 from the exterior of the sterilized pliable container 68. The free end of the inlet line 72, which is not connected to the first channel 60, may be open or sealed close.

The first and second channels 60, 62 have first and second tip openings at the tip end 64 of the piercing member 58, respectively; and first and second base openings at the base end of the piercing member 58, respectively. The first and second base openings may be located anywhere on the surface of the piercing member 58 outside the sterilized vial 52 and septum 56 when the piercing member 58 punctures through the septum 56 at the time of use. The first and second base openings are connected to the inlet and outlet lines 72, 74, respectively. When the piercing member 58 punctures through the septum 56 at the time of use, the first and second tip openings at the tip end 64 will be exposed to the interior or chamber of the sterilized vial 52, thereby fluidically connecting the interior or chamber of the sterilized vial 52 to the inlet and outlet lines 72, 74.

The system 200 may further comprise a sterilized holder 70, onto which the sterilized vial 52 and the piercing member 58 are mounted. The sterilized holder 70, together with the sterilized vial 52 and the piercing member 58, may be sealed in or enclosed by the sterilized pliable container 68 and may provide a guiding means or mechanism for the piercing member 58 to puncture the sterilized septum 56 in the sterilized pliable container 68 without breaching the sterilized pliable container 68 when one of the sterilized vial 52 and the piercing member 58 is manually pushed against the other one of the sterilized vial 52 and the piercing member 58 from the exterior of the sterilized pliable container 68.

The fluidic assembly of the system 200 may further comprise an optional check valve 80 inserted somewhere in or fluidically connected to the inlet line 72, and/or another optional check valve 82 inserted somewhere in or fluidically connected to the outlet line 74 to prevent backflow of the liquid substance 54 to the sterilized vial 52 during the transfer operation, and/or additional connectors inserted in or fluidically connected to the inlet and outlet lines 72, 74. The in-line air filter 78 may be inserted somewhere in or fluidically connected to the inlet line 72, including the beginning and end of the inlet line 72, for filtering the gas or air flowing from the environment outside the sterilized pliable pouch 68, thereby preserving the sterility of the chamber of the sterilized vial 52. The in-line air filter 78 and check valves 80, 82 may each be disposed inside or outside the sterilized pliable container 68.

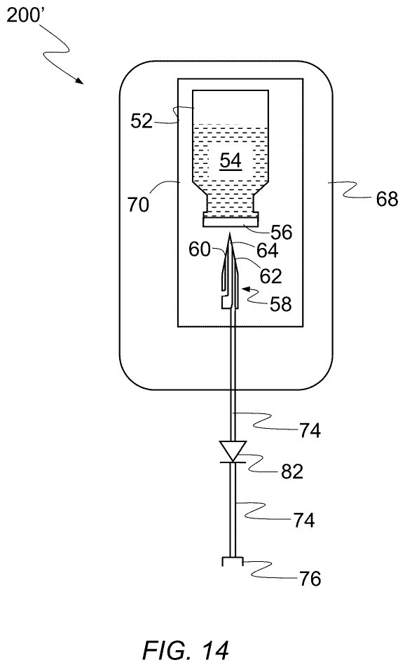

The system 200 may be further modified by terminating the inlet line 72 inside the sterilized pliable container 68 with the free end of the inlet line 72 being open or simply eliminating the inlet line 72 altogether, as shown in FIG. 14, thereby allowing fluidic communication between the chamber of the sterilized vial 52 and the sterilized gas or air environment inside the sterilized pliable container 68 through the first channel 60 of the piercing member 58 at the time of use. In contrast to the system 200 which draws air from outside the sterilized pliable container 68 to equilibrate the negative pressure in the sterilized vial 52 as the liquid substance 54 is being pumped, the system 200′ draws gas or air from inside the sterilized pliable container 68 to relieve the negative pressure.

The sterilized vial 52 may be made of glass and sealed by the sterilized septum 56 comprising an elastomeric material, such as but not limited to polytetrafluoroethylene (PTFE) or PTFE/silicone/PTFE laminates. The sterilized septum 56 may be held in place by a retainer (not shown) extending around the neck of the sterilized vial 52, and particularly around a collar or flange formed on the neck of the sterilized vial 52. The retainer may also extend partially over the exterior surface of the sterilized septum 56 to leave an exposed region of the sterilized septum 56 for access to the interior or chamber of the sterilized vial 52 with the piercing member 58. The sterilized vial 52 itself without the liquid substance 54 therein and the sterilized septum 56 may be sterilized by any suitable sterilization method, such as but not limited to steam sterilization, chemical sterilization, e-beam sterilization, or gamma ray radiation sterilization, prior to filling the sterilized vial 52 with the liquid substance 54 under an aseptic or sterile condition to prevent potential contamination.

The liquid substance 54 may comprise any substance or ingredient used in manufacturing of biologics, such as but not limited to water, buffer, cell culture media, serum, freeze media, transduction enhancer (e.g., peptide, polymer), protein (e.g., IL2, IL-15, or antibody), magnetic beads-antibody conjugates for cell sorting (i.e., magnetic labels), lipid nanoparticles, plasmids, virus, cells, extravascular suspension, or any combination thereof.

The piercing member 58 of the sterilized fluidic assembly may be made of a metallic, ceramic, or polymeric material that is sufficiently hard for puncturing through the elastomeric septum 56. For example and without limitation, the piercing member 58 may be made of stainless steel. The inlet line 72 and outlet line 74 of the sterilized fluidic assembly may be made of a pliable/flexible thermoplastic material, such as but not limited to polyvinyl chloride (PVC). The free end of the inlet line 72 in the system 200 may be hermetically sealed by heat-induced welding. At the time of use, the sealed end of the inlet line 72 may be cut off or severed to allow air from outside the sterilized pliable container 68 to flow through the inlet line 72 and into the chamber of the sterilized vial 52. For the modified system 200′, the inlet line, if present, is enclosed by the sterilized pliable container 68, and its free end is open to the sterilized gas or air environment inside the sterilized pliable container 68.

The free end of the outlet line 74 may be hermetically sealed by heat-induced welding. Prior to transferring the liquid substance 54 out of the sterilized vial 52, the free end of the outlet line 74 may be aseptically welded to another line connected to a receiving container (not shown), thereby aseptically transferring the liquid substance 54 to the receiving container. Alternatively, the free end of the outlet line 74 may be terminated by a male or female half of an aseptic connector 76, which is then connected to the opposite half of the aseptic connector attached to another line at the time of use. The male and female halves of the aseptic connector 76 each contain a sterile membrane, which is removed when the male and female halves are joined together, thereby forming a closed and sterile fluid path between the lines at the opposite ends of the aseptic connector 76.

The sterilized fluidic assembly, which includes the piercing member 58, the inlet line 72 (if present), the in-line air filter 78, and the optional check valves 80, 82 may be sterilized by heat, steam, gamma ray radiation, or other suitable means.

The sterilized pliable container 68 may be in the form of a bag or pouch and is sufficiently supple and resilient to allow the piercing member 58 to puncture the septum 56 by manual manipulation from the outside of the sterilized pliable container 68 without breaking or tearing the sterilized pliable container 68, thereby ensuring the interior of the sterilized pliable container 68 and all fluidic paths in the sterilized fluidic assembly remain sterile after establishing fluidic communication between the sterilized vial 52 and the inlet and outlet lines 72, 74. The sterilized pliable container 68 in the form of bag or pouch may be made of any suitable polymeric material, such as but not limited to PVC, and may be sterilized by ethylene oxide, alcohol, gamma ray radiation, or other suitable methods. The sterilized pliable container 68 may enclose at least the sterilized vial 52, the piercing member 58, segments of the inlet and outlet lines 72, 74 connected to the piercing member 58, and the sterilized holder 70, if any. If the piercing member 58 is designed to be pushed against the sterilized vial 52 at the time of use, then there may be some slack in the inlet and outlet lines 72, 74 inside the sterilized pliable container 68 to accommodate the movement of the piercing member 58. Other fluidic components, such as but not limited to the in-line air filter 78 and the optional check valves 80, 82, may also be sealed within or enclosed by the sterilized pliable container 68. The free end of the outlet line 74, which is welded close or terminated with a male or female half of the aseptic connector 76, will be aseptically connected to an external line at the time of use and therefore should not be enclosed in the sterilized pliable container 68. The free end of the inlet line 72 of the system 200 is not enclosed in the sterilized pliable container 68. The free end of the inlet line 72 of the modified system 200′ (if present), which is open, may be enclosed in the sterilized pliable container 68. The sterilized vial 52, the piercing member 58 of the sterilized fluidic assembly, and the sterilized holder 70, onto which the sterilized vial 52 and the piercing member 58 are separately mounted, may be sealed in or enclosed by the sterilized pliable container 68 in an aseptic or sterile environment to preserve the sterility of the components enclosed therein. The systems 200, 200′ may be discarded after the liquid substance 54 is transferred from the sterilized vial 52 to the receiving container (i.e. single-use application).

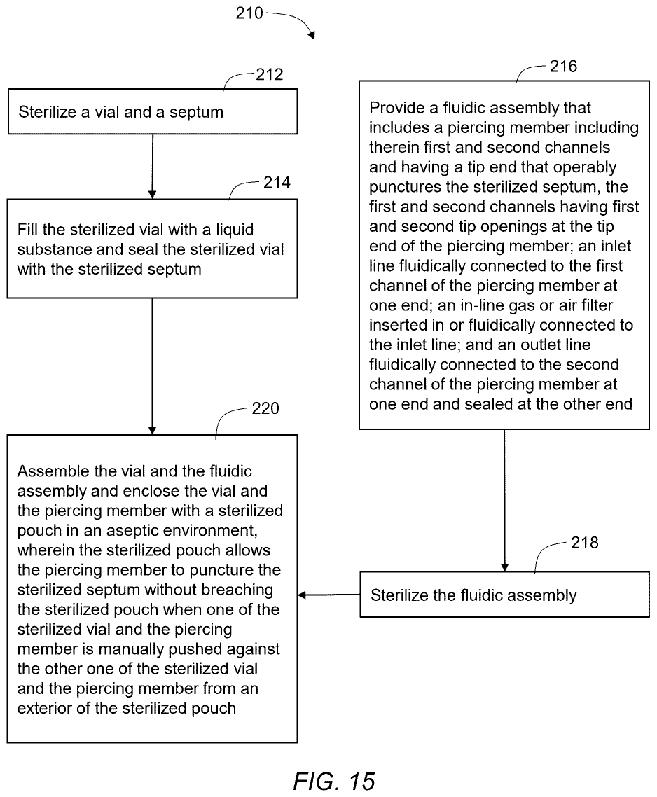

Manufacturing of the system 200 will now be described with reference to FIG. 13 and the flow diagram of FIG. 15, which illustrates selected steps 210 for fabricating the system 200 for aseptically transferring a liquid substance in accordance with an embodiment of the present invention. The manufacturing process of the system 200 is substantially similar to that of the system 50 as shown in FIG. 2 and described above, except for the absence of a manual air pump in the fluidic assembly of system 200. The process begins at step 212 by sterilizing a vial 52 and a septum 56. After sterilizing the vial 52 and the septum 56, the sterilized vial 52 is aseptically filled with the liquid substance 54 and sealed with the sterilized septum 56 in an aseptic or sterile environment at step 214.

At step 216, a fluidic assembly is provided that includes a piercing member 58 including therein first and second channels 60, 62 and having a tip end 64 that can operably puncture through the sterilized septum 56, the first and second channels having first and second tip openings at the tip end 64 of the piercing member 58; an inlet line 72 fluidically connected to the first channel 60 of the piercing member 58 at one end; an in-line gas or air filter 78 inserted in or fluidically connected to the inlet line 72 for filtering the air flowing from outside the sterilized pliable container 68, such as a pouch; and an outlet line 74 fluidically connected to the second channel 62 of the piercing member 58 at one end and sealed close at the other end, as described above with reference to FIG. 13. The fluidic assembly may further include an optional check valve 80 inserted in or fluidically connected to the inlet line 72 to prevent the backflow of air, and/or another optional check valve 82 inserted in or fluidically connected to the outlet line 74 to prevent backflow of the liquid substance 54 to the sterilized vial 52 during the transfer operation, and/or any additional connectors inserted in or fluidically connected to the inlet and outlet lines 72, 74.

After providing the fluidic assembly, the fluidic assembly is sterilized by a suitable means, such as but not limited to heat, steam, or gamma ray radiation, at step 218.

Since the sterilization of the vial 52 is independent of the sterilization of the fluidic assembly, steps 212/214 and steps 216/218 can be carried out in the reversed order (i.e., steps 216/218 and then steps 212/214) or simultaneously.

Next, at step 220, the sterilized vial 52 and the sterilized fluidic assembly are assembled, and the sterilized vial 52 and the piercing member 58 are sealed in or enclosed by a sterilized pouch 68 in an aseptic or sterile environment. The sterilized pouch 68 allows the piercing member 58 to puncture the sterilized septum 56 without breaching the sterilized pouch 68 when one of the sterilized vial 52 and the piercing member 58 is manually pushed against the other one of the sterilized vial 52 and the piercing member 58 from the exterior of the sterilized pouch 68.

The sterilized vial 52 and the piercing member 58 may be separately mounted on a sterilized holder 70 that provides a guiding mechanism for the piercing member 58 to puncture the sterilized septum 56 of the sterilized vial 52 in the sterilized pouch 68 at the time of use. The sterilized holder 70, together with the sterilized vial 52 and the piercing member 58, may be sealed in or enclosed by the sterilized pouch 68 at step 220.

The manufacturing process for the modified system 200′ is substantially similar to that of the system 200 shown in FIG. 15 and described above, except that the fluidic assembly of the modified system 200′ may not have an inlet line and an in-line gas or air filter at step 216. In embodiments where an inlet line is present in the fluidic assembly of the modified system 200′, the inlet line, with its free end remaining open, is enclosed in the sterilized pouch 68 along with the sterilized vial 52 and the piercing member 58 at step 220.

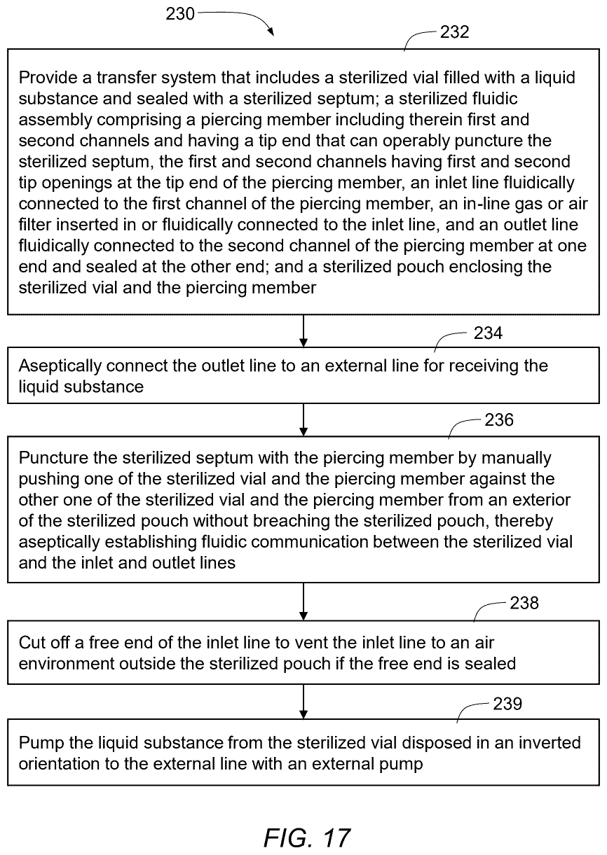

Operation of the system 200 will now be described with reference to FIGS. 13, 16, and 17. The flow diagram of FIG. 17 illustrates selected steps 230 for using the system 200 to aseptically transfer a liquid substance from a vial in accordance with an embodiment of the present invention. The process begins at step 232 by providing a transfer system 200 that includes a sterilized vial 52 filled with a liquid substance 54 and sealed with a sterilized septum 56; a sterilized fluidic assembly comprising a piercing member 58 including therein first and second channels 60, 62 and having a tip end 64 that can operably puncture through the sterilized septum 56, the first and second channels 60, 62 having first and second tip openings at the tip end 64 of the piercing member 58, an inlet line 72 fluidically connected to the first channel 60 of the piercing member 58 at one end, an in-line gas or air filter 78 inserted in or fluidically connected to the inlet line 72 for filtering air flowing through the inlet line 72, and an outlet line 74 fluidically connected to the second channel 62 of the piercing member 58 at one end and sealed close at the other end; and a sterilized pouch 68 enclosing the sterilized vial 52 and the piercing member 58.

The system 200 may further include a sterilized holder 70. The sterilized vial 52 and the piercing member 58 may be separately mounted on the sterilized holder 70 that provides a guiding mechanism for the piercing member 58 to puncture the sterilized septum 56 of the sterilized vial 52 in the sterilized pouch 68. The sterilized holder 70, together with the sterilized vial 52 and the piercing member 58, may be sealed in or enclosed by the sterilized pouch 68. The sterilized holder 70 may be made of any moldable material that has sufficient mechanical rigidity and can withstand the sterilization process, such as but not limited to thermoplastic materials.

Next, at step 234, the outlet line 74 is aseptically connected to an external line 84 for receiving the liquid substance 54. The other end of the external line 84 may be connected to a receiving container (not shown). For the outlet line 74 sealed by thermal welding, this may be carried out by using a commercial tube welder that maintains the sterility of the connection. For the outlet line 74 that uses an aseptic connector, this may be carried out by connecting the male or female half of the aseptic connector 76 attached to the free end of the outlet line 74 to the opposite half of the aseptic connector 76 attached to the external line 84.

At step 236, the sterilized septum 56 is punctured with the piercing member 58 by manually pushing one of the sterilized vial 52 and the piercing member 58 against the other one of the sterilized vial 52 and the piercing member 58 from an exterior of the sterilized pouch 68 without breaching the sterilized pouch 68, thereby aseptically establishing fluidic communications between the sterilized vial 52 and the inlet and outlet lines 72, 74.

In embodiments where the inlet line 72 is sealed close at its free end, the free end is cut off or severed from the inlet line 72 to vent the inlet line 72 to the air environment outside the sterilized pouch 68 at step 238, thereby enabling fluidic communication between the chamber of the sterilized vial 52 and the air environment outside the sterilized pouch 68. The in-line air filter 78 may be used to preserve the sterility in the chamber of the sterilized vial 52 as air flows into the chamber during the transfer operation. Steps 234, 236, and 238 may be carried out in any order or simultaneously. For embodiments where the free end of the inlet line 72 is open, step 238 may be omitted.

After steps 234-238, the liquid substance 54 in the sterilized vial 52, oriented in an inverted position (i.e., the tip opening of the second channel 62 of the piercing member 58 is submerged in the liquid substance 54), is pumped through the outlet line 74 and the external line 84 and into the receiving container (not shown) by an external pump (not shown) at step 239. For example, the external pump may be a peristaltic pump engaging the external line 84 or an in-line pump fluidically connected to the external line 84. As the liquid substance 54 flows out of the sterilized vial 52, the inlet line 72 with its sealed end cut off allows air to flow from outside the sterilized pouch 68 into the chamber of the sterilized vial 52, thereby equilibrating the pressure inside the chamber to facilitate the flow of the liquid substance 54. If only a portion of the liquid substance 54 in the sterilized vial 52 needs to be transferred to the receiving container, the sterilized vial 52 may be reoriented in an upright position (i.e., the tip opening of the second channel 62 of the piercing member 58 is not covered by the liquid substance 54) after the portion of the liquid substance 54 has been transferred out of the sterilized vial 52. After the sterilized vial 52 is reoriented in the upright position, the pumping of the liquid substance 54 by the external pump may continue to extract the residual liquid substance 54 remaining in the outlet line 74 and the external line 84 into the receiving container without further draining the liquid substance 54 remaining in the sterilized vial 52.

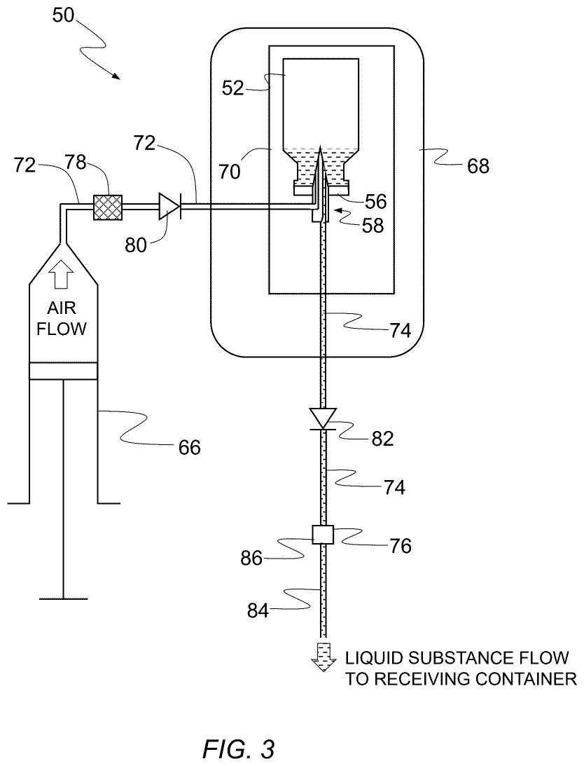

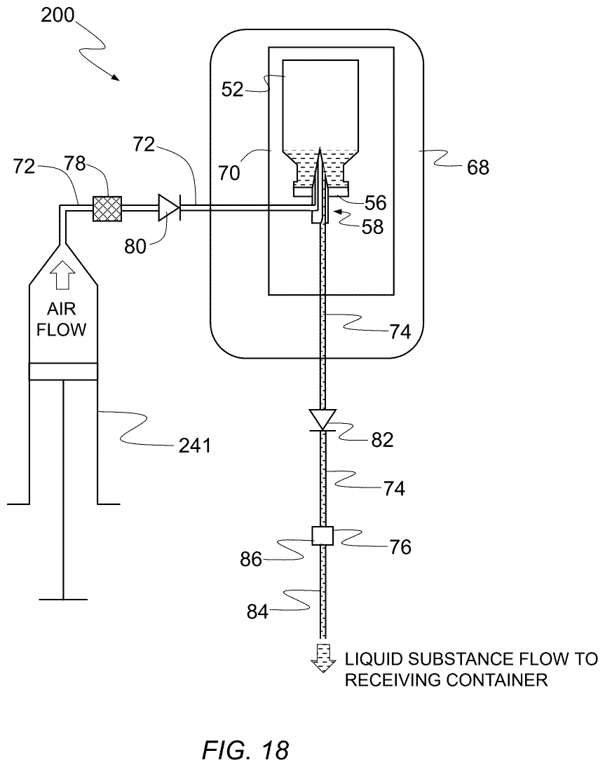

The system 200 may alternatively operate with an external air pump 241 fluidically connected to the free end of the inlet line 72 at the time of use as shown in FIG. 18. The external air pump 241 may be any suitable electric or manual pump that is capable of injecting air into the sterilized vial 52, such as but not limited to syringe pump, diaphragm pump, piston or plunger pump, rotary pump, or any type of centrifugal pump. Operation of the system 200 with the external air pump 241 is analogous to the operation of the system 50 shown in FIGS. 3, 4 and described above.

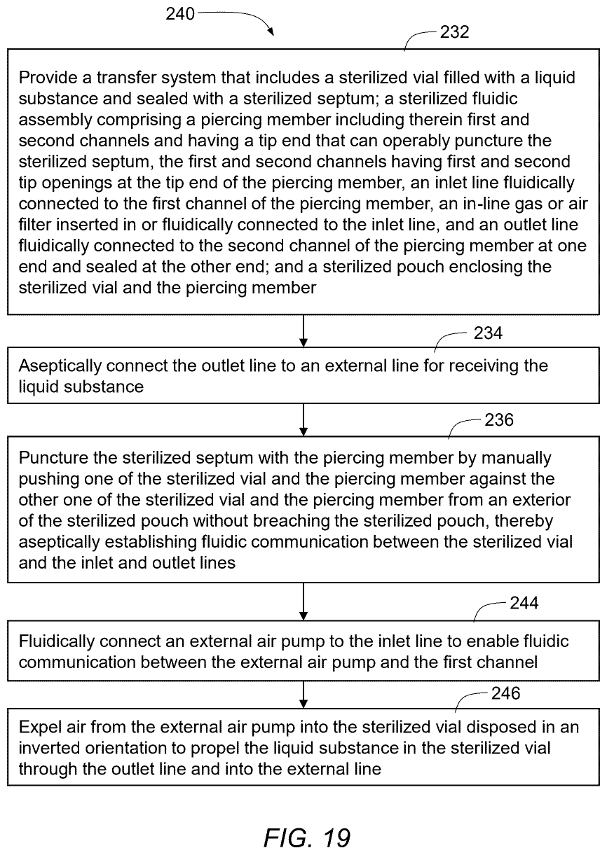

The flow diagram of FIG. 19 illustrates selected steps 240 for using the system 200 to aseptically transfer a liquid substance from a vial with the external air pump 241. The process begins at step 232 by providing a transfer system 200 that includes a sterilized vial 52 filled with a liquid substance 54 and sealed with a sterilized septum 56; a sterilized fluidic assembly comprising a piercing member 58 including therein first and second channels 60, 62 and having a tip end 64 that can operably puncture through the sterilized septum 56, the first and second channels 60, 62 having first and second tip openings at the tip end 64 of the piercing member 58, an inlet line 72 fluidically connected to the first channel 60 of the piercing member 58 at one end, an in-line gas or air filter 78 inserted in or fluidically connected to the inlet line 72 for filtering air flowing through the inlet line 72, and an outlet line 74 fluidically connected to the second channel 62 of the piercing member 58 at one end and sealed close at the other end; and a sterilized pouch 68 enclosing the sterilized vial 52 and the piercing member 58.

The system 200 may further include a sterilized holder 70. The sterilized vial 52 and the piercing member 58 may be separately mounted on the sterilized holder 70 that provides a guiding mechanism for the piercing member 58 to puncture the sterilized septum 56 of the sterilized vial 52 in the sterilized pouch 68. The sterilized holder 70, together with the sterilized vial 52 and the piercing member 58, may be sealed in or enclosed by the sterilized pouch 68. The sterilized holder 70 may be made of any moldable material that has sufficient mechanical rigidity and can withstand the sterilization process, such as but not limited to thermoplastic materials.

Next, at step 234, the outlet line 74 is aseptically connected to an external line 84 for receiving the liquid substance 54. The other end of the external line 84 may be connected to a receiving container (not shown). For the outlet line 74 sealed by thermal welding, this may be carried out by using a commercial tube welder that maintains the sterility of the connection. For the outlet line 74 that uses an aseptic connector, this may be carried out by connecting the male or female half of the aseptic connector 76 attached to the free end of the outlet line 74 to the opposite half of the aseptic connector 76 attached to the external line 84.

At step 236, the sterilized septum 56 is punctured with the piercing member 58 by manually pushing one of the sterilized vial 52 and the piercing member 58 against the other one of the sterilized vial 52 and the piercing member 58 from an exterior of the sterilized pouch 68 without breaching the sterilized pouch 68, thereby aseptically establishing fluidic communications between the sterilized vial 52 and the inlet and outlet lines 72, 74.

At step 244, the external air pump 241 is fluidically connected to the free end of the inlet line 72 to enable fluidic communication between the external air pump 241 and the first channel 60 of the piercing member 58. In embodiments where the inlet line 72 is sealed close at its free end, the free end may be cut off or severed from the inlet line 72 to prior to making the connection to the external air pump 241. The in-line air filter 78 may be used to preserve the sterility in the chamber of the sterilized vial 52 as air flows into the chamber during the transfer operation. Steps 234, 236, and 244 may be carried out in any order or simultaneously.

After steps 234, 236, and 244, the external air pump 241 pushes air into the sterilized vial 52 oriented in an inverted position (i.e., the tip opening of the second channel 62 of the piercing member 58 is submerged in the liquid substance 54) to propel the liquid substance 54 in the sterilized vial 52 through the outlet line 74 and the external line 84 and into the receiving container at step 246. If only a portion of the liquid substance 54 in the sterilized vial 52 needs to be transferred to the receiving container, the sterilized vial 52 may be reoriented in an upright position (i.e., the tip opening of the second channel 62 of the piercing member 58 is not covered by the liquid substance 54) after the portion of the liquid substance 54 has been transferred out of the sterilized vial 52. After the sterilized vial 52 is reoriented in the upright position, the external air pump 241 may continue to inject air into the sterilized vial 52, thereby pushing the residual liquid substance 54 remaining in the outlet line 74 and the external line 84 into the receiving container without further draining the liquid substance 54 remaining in the sterilized vial 52.

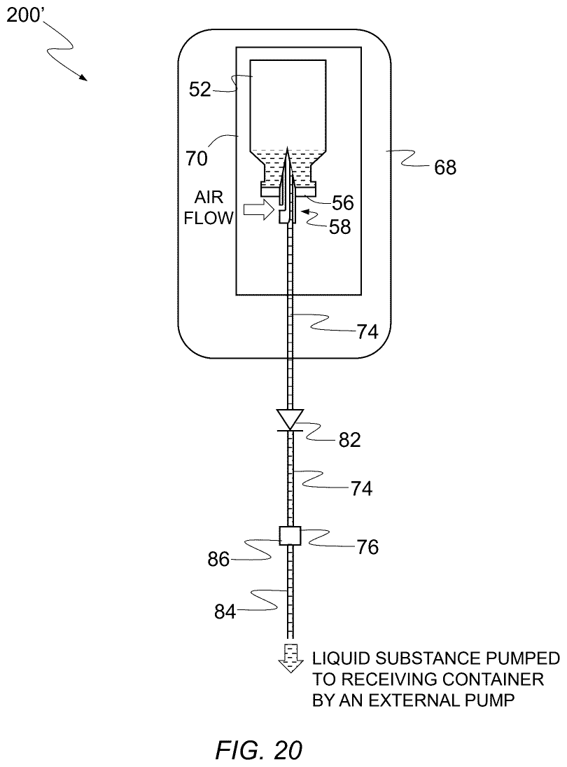

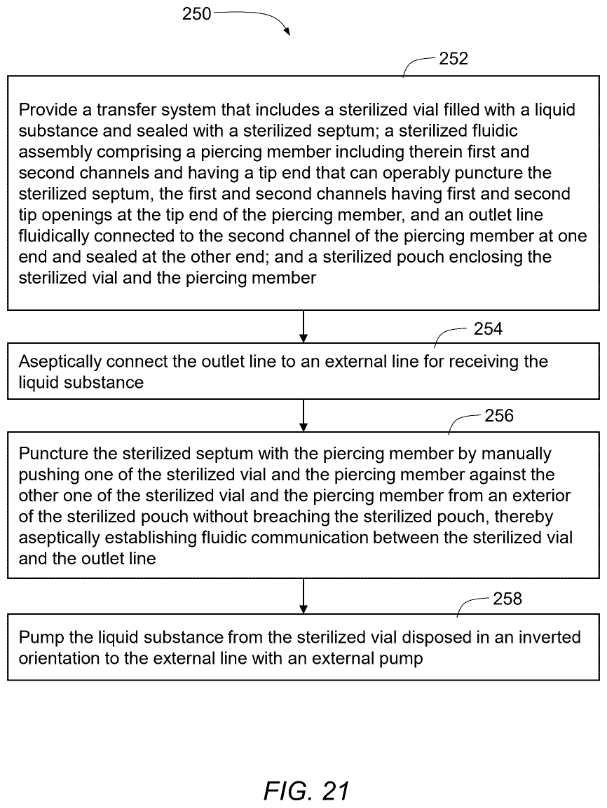

Operation of the modified system 200′ will now be described with reference to FIGS. 14, 20, and 21. The flow diagram of FIG. 21 illustrates selected steps 250 for using the modified system 200′ to aseptically transfer a liquid substance from a vial in accordance with an embodiment of the present invention. The process begins at step 252 by providing a transfer system 200′ that includes a sterilized vial 52 filled with a liquid substance 54 and sealed with a sterilized septum 56; a sterilized fluidic assembly comprising a piercing member 58 including therein first and second channels 60, 62 and having a tip end 64 that can operably puncture through the sterilized septum 56, the first and second channels 60, 62 having first and second tip openings at the tip end 64 of the piercing member 58, and an outlet line 74 fluidically connected to the second channel 62 of the piercing member 58 at one end and sealed close at the other end; and a sterilized pouch 68 enclosing the sterilized vial 52 and the piercing member 58. The base opening of the first channel 60 may be directly exposed to the sterilized gas or air environment inside the sterilized pouch 68 or indirectly through an optional inlet line connected to the first channel 60 of the piercing member 58.

The modified system 200′ may further include a sterilized holder 70. The sterilized vial 52 and the piercing member 58 may be separately mounted on the sterilized holder 70 that provides a guiding mechanism for the piercing member 58 to puncture the sterilized septum 56 of the sterilized vial 52 in the sterilized pouch 68. The sterilized holder 70, together with the sterilized vial 52 and the piercing member 58, may be sealed in or enclosed by the sterilized pouch 68. The sterilized holder 70 may be made of any moldable material that has sufficient mechanical rigidity and can withstand the sterilization process, such as but not limited to thermoplastic materials.

Next, at step 254, the outlet line 74 is aseptically connected to an external line 84 for receiving the liquid substance 54. The other end of the external line 84 may be connected to a receiving container (not shown). For the outlet line 74 sealed by thermal welding, this may be carried out by using a commercial tube welder that maintains the sterility of the connection. For the outlet line 74 that uses an aseptic connector, this may be carried out by connecting the male or female half of the aseptic connector 76 attached to the free end of the outlet line 74 to the opposite half of the aseptic connector 76 attached to the external line 84.

At step 256, the sterilized septum 56 is punctured with the piercing member 58 by manually pushing one of the sterilized vial 52 and the piercing member 58 against the other one of the sterilized vial 52 and the piercing member 58 from an exterior of the sterilized pouch 68 without breaching the sterilized pouch 68, thereby aseptically establishing fluidic communications between the sterilized vial 52 and the outlet line 74 and between the sterilized vial 52 and the sterilized gas or air environment inside the sterilized pouch 68. Steps 254 and 256 may be carried out in the reversed order or simultaneously.

After steps 254 and 256, the liquid substance 54 in the sterilized vial 52, oriented in an inverted position (i.e., the tip opening of the second channel 62 of the piercing member 58 is submerged in the liquid substance 54), is pumped through the outlet line 74 and the external line 84 and into the receiving container (not shown) by an external pump (not shown) at step 258. For example, the external pump may be a peristaltic pump engaging the external line 84 or an in-line pump fluidically connected to the external line 84. As the liquid substance 54 flows out of the sterilized vial 52, the gas or air inside the sterilized pouch 68 flows into the chamber of the sterilized vial 52 via the first channel 60, thereby equilibrating the pressure inside the chamber to facilitate the flow of the liquid substance 54. If only a portion of the liquid substance 54 in the sterilized vial 52 needs to be transferred to the receiving container, the sterilized vial 52 may be reoriented in an upright position (i.e., the tip opening of the second channel 62 of the piercing member 58 is not covered by the liquid substance 54) after the portion of the liquid substance 54 has been transferred out of the sterilized vial 52. After the sterilized vial 52 is reoriented in the upright position, the pumping of the liquid substance 54 by the external pump may continue to extract the residual liquid substance 54 remaining in the outlet line 74 and the external line 84 into the receiving container without further draining the liquid substance 54 remaining in the sterilized vial 52.

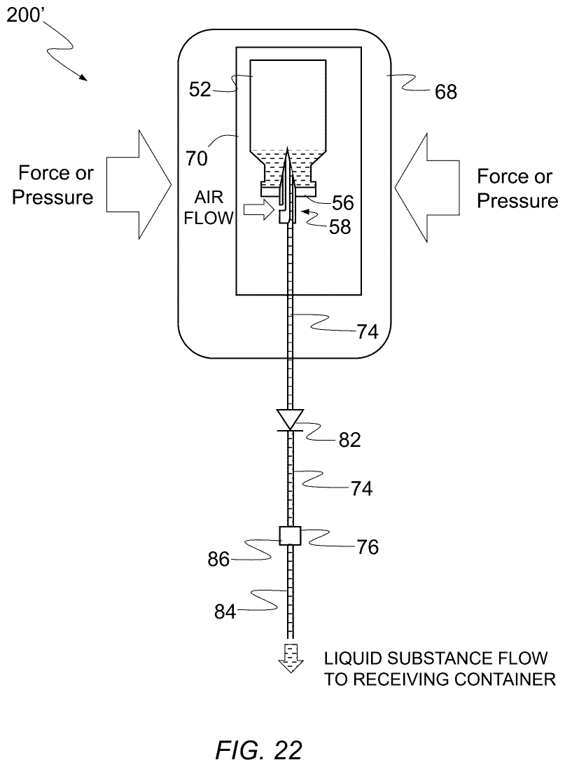

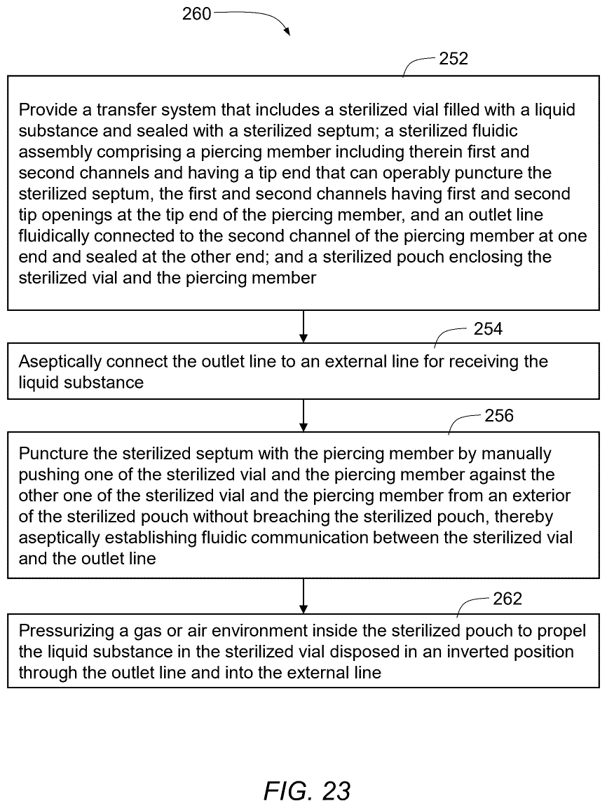

The modified system 200′ may alternatively operate without the aid an external pump at the time of use as shown in FIGS. 22 and 23. Using a sterilized pouch 68 made of a material that is sufficiently durable to withstand a higher internal pressure, the sterilized pouch 68 may be inflated to a pressure higher than the barometric pressure of the operating environment during manufacturing. At the time of use, the elevated pressure in the sterilized pouch 68, which may be further increased by squeezing the sterilized pouch 68, may be used to propel the liquid substance 54 out of the sterilized vial 52 after the sterilized septum 56 is punctured by the piercing member 58 to establish fluid communication between the chamber of the sterilized vial 52 and the gas or air environment inside the sterilized pouch 68.

The flow diagram of FIG. 23 illustrates selected steps 260 for using the modified system 200′ to aseptically transfer a liquid substance from a vial without the aid of an external pump. The process begins at step 252 by providing a transfer system 200′ that includes a sterilized vial 52 filled with a liquid substance 54 and sealed with a sterilized septum 56; a sterilized fluidic assembly comprising a piercing member 58 including therein first and second channels 60, 62 and having a tip end 64 that can operably puncture through the sterilized septum 56, the first and second channels 60, 62 having first and second tip openings at the tip end 64 of the piercing member 58, and an outlet line 74 fluidically connected to the second channel 62 of the piercing member 58 at one end and sealed close at the other end; and a sterilized pouch 68 enclosing the sterilized vial 52 and the piercing member 58. The base opening of the first channel 60 may be directly exposed to the sterilized gas or air environment inside the sterilized pouch 68 or indirectly through an optional inlet line connected to the first channel 60 of the piercing member 58. The sterilized pouch 68 may be inflated to a pressure higher than the barometric pressure of the operating environment.

The modified system 200′ may further include a sterilized holder 70. The sterilized vial 52 and the piercing member 58 may be separately mounted on the sterilized holder 70 that provides a guiding mechanism for the piercing member 58 to puncture the sterilized septum 56 of the sterilized vial 52 in the sterilized pouch 68. The sterilized holder 70, together with the sterilized vial 52 and the piercing member 58, may be sealed in or enclosed by the sterilized pouch 68. The sterilized holder 70 may be made of any moldable material that has sufficient mechanical rigidity and can withstand the sterilization process, such as but not limited to thermoplastic materials.

Next, at step 254, the outlet line 74 is aseptically connected to an external line 84 for receiving the liquid substance 54. The other end of the external line 84 may be connected to a receiving container (not shown). For the outlet line 74 sealed by thermal welding, this may be carried out by using a commercial tube welder that maintains the sterility of the connection. For the outlet line 74 that uses an aseptic connector, this may be carried out by connecting the male or female half of the aseptic connector 76 attached to the free end of the outlet line 74 to the opposite half of the aseptic connector 76 attached to the external line 84.

At step 256, the sterilized septum 56 is punctured with the piercing member 58 by manually pushing one of the sterilized vial 52 and the piercing member 58 against the other one of the sterilized vial 52 and the piercing member 58 from an exterior of the sterilized pouch 68 without breaching the sterilized pouch 68, thereby aseptically establishing fluidic communications between the sterilized vial 52 and the outlet line 74 and between the sterilized vial 52 and the sterilized gas or air environment inside the sterilized pouch 68.

After steps 254 and 256, the liquid substance 54 in the sterilized vial 52, oriented in an inverted position (i.e., the tip opening of the second channel 62 of the piercing member 58 is submerged in the liquid substance 54), may flow through the outlet line 74 and the external line 84 and into the receiving container (not shown) as the chamber of the sterilized vial 52 is pressurized by the gas or air pressure inside the sterilized pouch 68 at step 262. The sterilized pouch 68 may be squeezed to further increase the pressure inside the sterilized pouch 68 and inside the chamber of the sterilized vial 52 to facilitate the flow of the liquid substance 54 out of the sterilized vial 52.

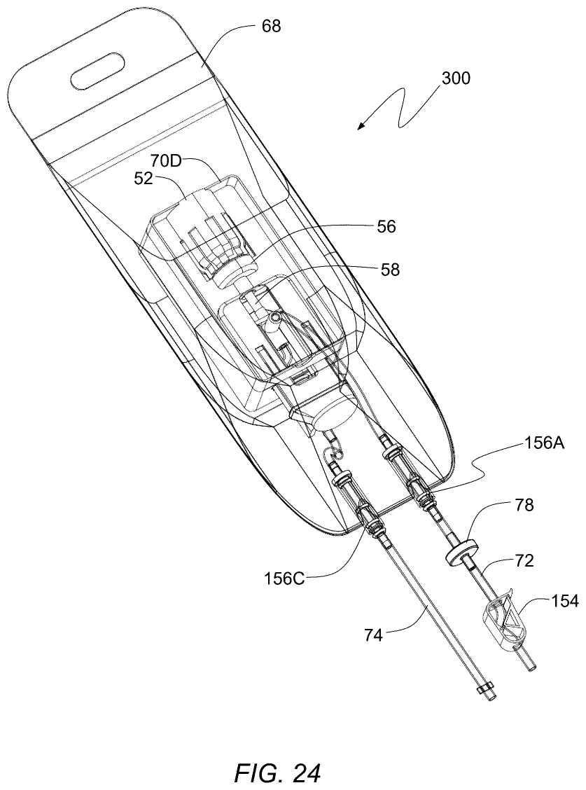

The following examples are provided to illustrate, but not limit the invention. FIG. 24 is a perspective view of an exemplary system 300 for aseptically transferring a fluid substance from a vial in accordance with the embodiment 200 of FIG. 13. The system 300 comprises a sterilized vial 52 filled with a liquid substance and sealed with a sterilized septum 56, a sterilized fluidic assembly, a sterilized holder 70D, and a sterilized pouch 68.

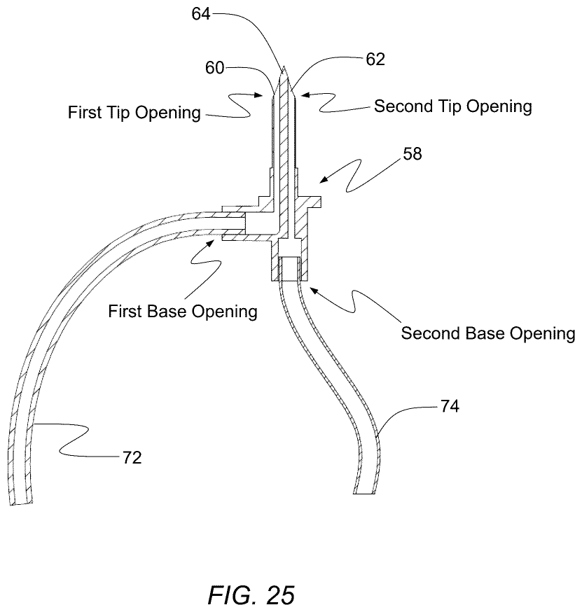

The sterilized fluidic assembly of the system 300 comprises a piercing member 58 including therein a first channel 60 and a second channel 62 and having a tip end 64 that can operably puncture through the sterilized septum 56, as shown in FIG. 25. The first and second channels 60, 62 have first and second tip openings at the tip end 64 of the piercing member 58, respectively; and first and second base openings at the base end of the piercing member 58, respectively. The first and second base openings may be located anywhere on the surface of the piercing member 58 outside the sterilized vial 52 and septum 56 when the piercing member 58 punctures through the septum 56 at the time of use.

Referring back to FIG. 24, the sterilized fluidic assembly further comprises an inlet line 72 fluidically connected to the first channel 60 of the piercing member 58 at its base opening and extending to outside the sterilized pouch 68 through a pass-through connector 156A, an in-line gas or air filter 78 inserted between segments of the inlet line 72 for filtering air flowing through the inlet line 72, and an outlet line 74 fluidically connected to the second channel 62 of the piercing member 58 at its base opening and extending to outside the sterilized pouch 68 through a pass-through connector 156C. The free end of the outlet line 74 located outside the sterilized pouch 68 may be hermetically sealed by heat-induced welding. The inlet line 72 includes the in-line air filter 78 for filtering air from the environment outside the sterilized pouch 68 and an optional pinch valve or clamp 154 for regulating the air flow through the inlet line 72. The free end of the inlet line 72 located outside the sterilized pouch 68 may be sealed close during manufacturing. Alternatively, the free end of the inlet line 72 may be left open because the in-line air filter 78 (e.g., 0.22 μm filter) can exclude bacteria and other contaminants from entering the first channel 60, thereby preserving the sterility of the sterilized pouch 68 and the sterilized vial 52.

The sterilized vial 52, the sterilized holder 70D, and a part of the sterilized fluidic assembly including the piercing member 58, a segment of the outlet line 74, and a segment of the inlet line 72, are enclosed by the sterilized pouch 68 to preserve sterility. The inlet and outlet lines 72, 74 pass through the sterilized pouch 68 via the pass-through connectors 156A, 156C, respectively. The pass-through connectors 156A, 156C may extend through the sealed sterilized pouch 68 along a seam thereof.

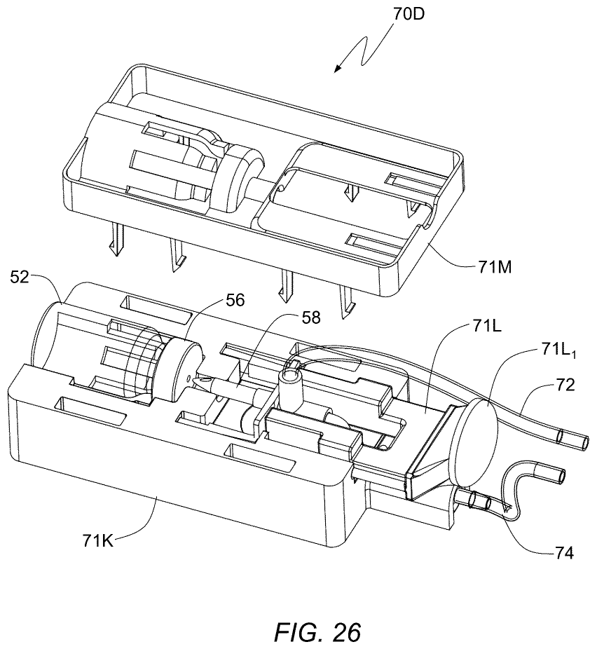

FIG. 26 is a perspective view of the portion of the exemplary system 300 that is sealed in or enclosed by the sterilized pouch 68, including the sterilized holder 70D, which comprises a base 71K, a press structure 71L that is fitted into a first slot at one end of the base 71K, and a cover 71M, the piercing member 58 attached to the press structure 71L and disposed in the first slot, segments of the inlet and outlet lines 72, 74 connected to the piercing member 58, and the sterilized vial 52 fitted into a second slot at the opposite end of the base 71K, with the sterilized septum 56 aligned to the piercing member 58. The cover 71M of the sterilized holder 70D may be attached to the base 71K of the sterilized holder 70D to secure the sterilized vial 52, the press structure 71L, and the piercing member 58 between the base 71K and cover 71M. At the time of use, a knob structure 71L₁ at one end of the press structure 71L may be manually pushed towards the sterilized vial 52 from the outside of the sterilized pouch 68, thereby puncturing through the sterilized septum 56 by the piercing member 58 and establishing fluidic communications between the sterilized vial 52 and the inlet and outlet lines 72, 74.

Operation of the system 300 for aseptically transferring the liquid substance in the sterilized vial 52 to a receiving container will now be described with reference to FIGS. 24-26. The free end of the outlet line 74 may be aseptically connected to an external line fluidically connected to the receiving container (not shown) by a commercial tube welder. The pinch clamp 154 attached to the inlet line 72 may be released and the free end of the inlet line 72 may be cut off or severed if the free end is sealed close during manufacturing, thereby allowing fluidic communication between the first channel 60 of the piercing member 58 and the environment outside the sterilized pouch 68 through the in-line gas or air filter 78. The press structure 71L may be manually pushed towards the sterilized vial 52 from the outside of the sterilized pouch 68 to puncture through the sterilized septum 56 by the piercing member 58, thereby establishing aseptic fluidic communications between the sterilized vial 52 and the inlet and outlet lines 72, 74. With the sterilized vial 52 hung upside down, the liquid substance in the sterilized vial 52 is pumped through the outlet line 74 and the external line and into the receiving container (not shown) by an external pump (not shown). For example, the external pump may be a peristaltic pump engaging the external line or an in-line pump fluidically connected to the external line. As the liquid substance flows out of the sterilized vial 52, the inlet line 72 allows air to flow from outside the sterilized pouch 68 into the chamber of the sterilized vial 52, thereby equilibrating the pressure inside the chamber to facilitate the flow of the liquid substance.

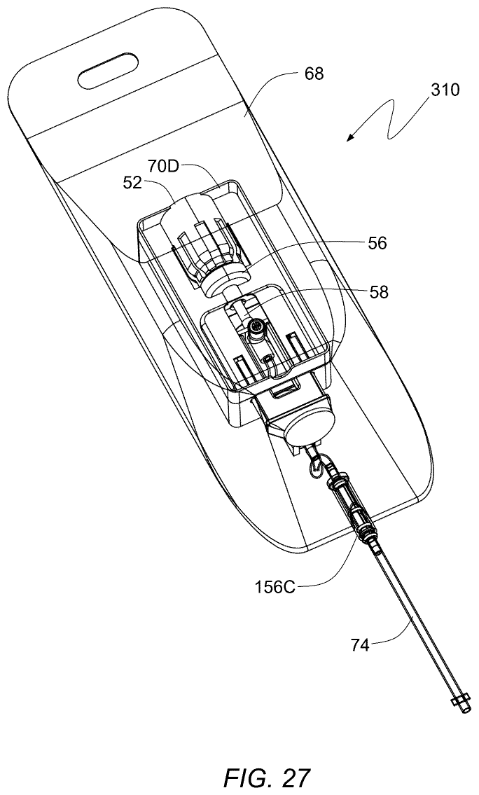

FIG. 27 is a perspective view of an exemplary system 310 for aseptically transferring a fluid substance from a vial in accordance with the embodiment 200′ of FIG. 14. The system 310 comprises a sterilized vial 52 filled with a liquid substance and sealed with a sterilized septum 56, a sterilized fluidic assembly, a sterilized holder 70D, and a sterilized pouch 68. Compared with the system 300 shown in FIG. 24, the sterilized fluidic assembly of the system 310 does not have an inlet line and associated components attached thereto.

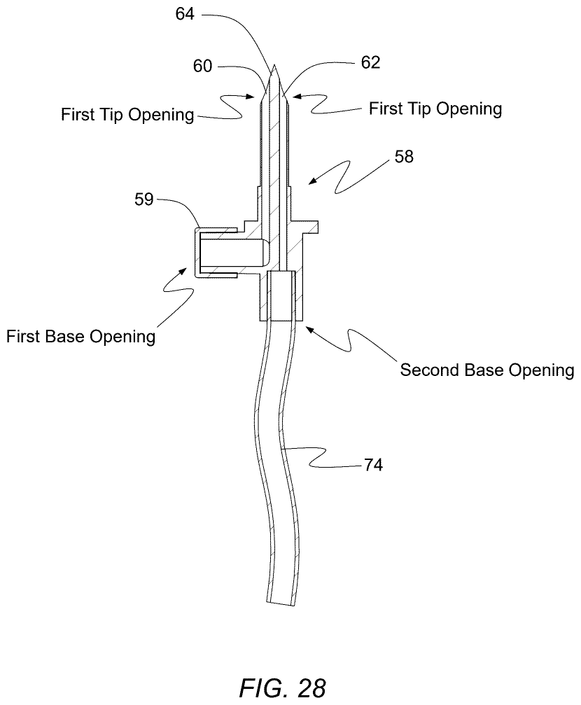

The sterilized fluidic assembly of the system 310 comprises a piercing member 58 including therein a first channel 60 and a second channel 62 and having a tip end 64 that can operably puncture through the sterilized septum 56, as shown in FIG. 28. The first and second channels 60, 62 have first and second tip openings at the tip end 64 of the piercing member 58, respectively; and first and second base openings at the base end of the piercing member 58, respectively. The first and second base openings may be located anywhere on the surface of the piercing member 58 outside the sterilized vial 52 and septum 56 when the piercing member 58 punctures through the septum 56 at the time of use. The first base opening of the first channel may be capped with an optional filter 59 to prevent foreign objects from entering the opening and clogging the channel.

Referring back to FIG. 27, the sterilized fluidic assembly further comprises an outlet line 74 fluidically connected to the second channel 62 of the piercing member 58 at the second base opening and extending to outside the sterilized pouch 68 through a pass-through connector 156C. The free end of the outlet line 74 located outside the sterilized pouch 68 may be hermetically sealed by heat-induced welding.

The sterilized vial 52, the sterilized holder 70D, and a part of the sterilized fluidic assembly including the piercing member 58 and a segment of the outlet line 74 are enclosed by the sterilized pouch 68 to preserve sterility. The outlet line 74 passes through the sterilized pouch 68 via the pass-through connector 156C. The pass-through connector 156C may extend through the sealed sterilized pouch 68 along a seam thereof.

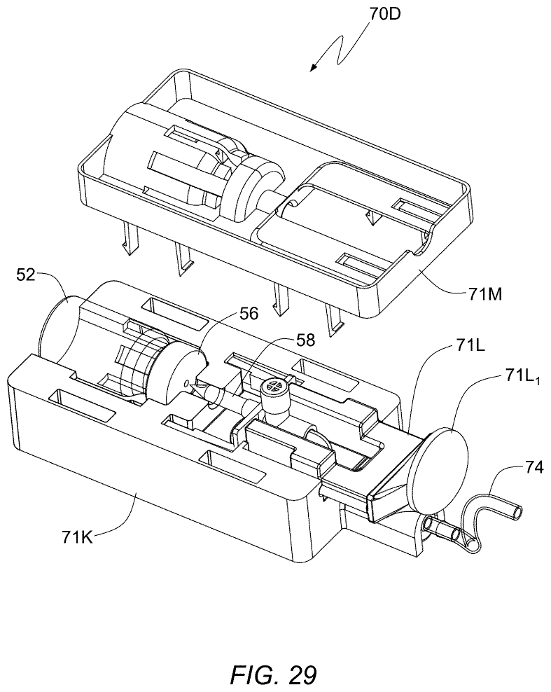

FIG. 29 is a perspective view of the portion of the exemplary system 310 that is sealed in or enclosed by the sterilized pouch 68, including the sterilized holder 70D, which comprises a base 71K, a press structure 71L that is fitted into a first slot at one end of the base 71K, and a cover 71M, the piercing member 58 attached to the press structure 71L and disposed in the first slot, the segment of the outlet line 74 connected to the piercing member 58, and the sterilized vial 52 fitted into a second slot at the opposite end of the base 71K, with the sterilized septum 56 aligned to the piercing member 58. The cover 71M of the sterilized holder 70D may be attached to the base 71K of the sterilized holder 70D to secure the sterilized vial 52, the press structure 71L, and the piercing member 58 between the base 71K and cover 71M. At the time of use, a knob structure 71L₁ at one end of the press structure 71L may be manually pushed towards the sterilized vial 52 from the outside of the sterilized pouch 68, thereby puncturing through the sterilized septum 56 by the piercing member 58 and establishing fluidic communications between the chamber of the sterilized vial 52 and the outlet line 74 and between the chamber of the sterilized vial 52 and the sterile environment inside the sterilized pouch 68.

Operation of the system 310 for aseptically transferring the liquid substance in the sterilized vial 52 to a receiving container will now be described with reference to FIGS. 27-29. The free end of the outlet line 74 may be aseptically connected to an external line fluidically connected to a receiving container (not shown) by a commercial tube welder. The press structure 71L may be manually pushed towards the sterilized vial 52 from the outside of the sterilized pouch 68 to puncture through the sterilized septum 56 by the piercing member 58, thereby establishing aseptic fluidic communications between the sterilized vial 52 and the outlet line 74 and between the sterilized vial 52 and the sterilized gas or air environment inside the sterilized pouch 68. With the sterilized vial 52 hung upside down, the liquid substance in the sterilized vial 52 is pumped through the outlet line 74 and the external line and into the receiving container (not shown) by an external pump (not shown). For example, the external pump may be a peristaltic pump engaging the external line or an in-line pump fluidically connected to the external line. As the liquid substance flows out of the sterilized vial 52, the first channel 60 of the piercing member 58 allows gas or air to flow from inside the sterilized pouch 68 into the chamber of the sterilized vial 52, thereby equilibrating the pressure inside the chamber to facilitate the flow of the liquid substance.

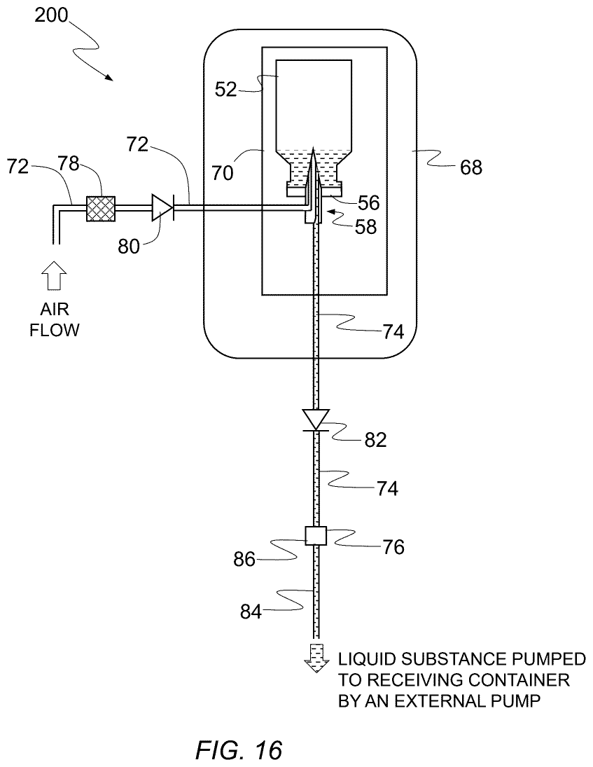

The present invention provides a method for aseptically transferring a liquid substance with or without the aid of an external pump. While the fluid transfer system 50 of FIG. 1 may be equipped with a manual air pump 66 in the form of a syringe for pushing the liquid substance 54 out of the sterilized vial 52, the system 50 may alternatively be operated with an external pump like the system 200 shown in FIG. 16.

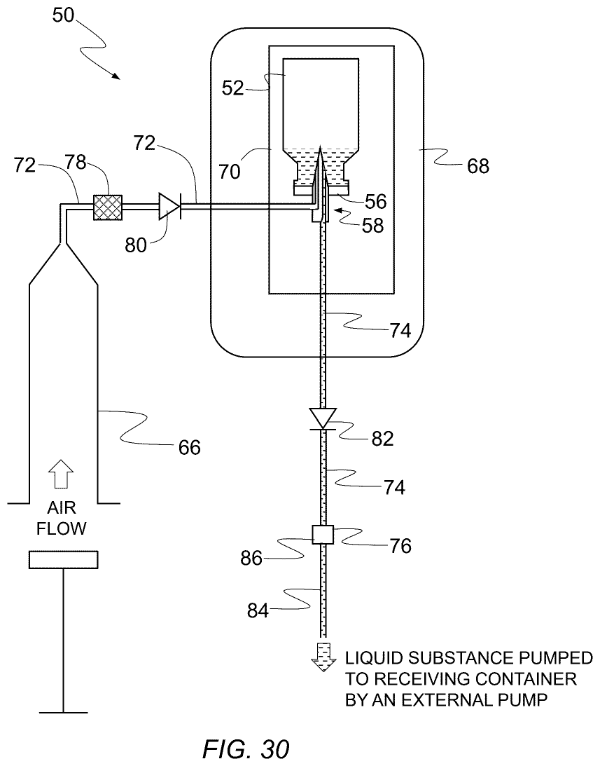

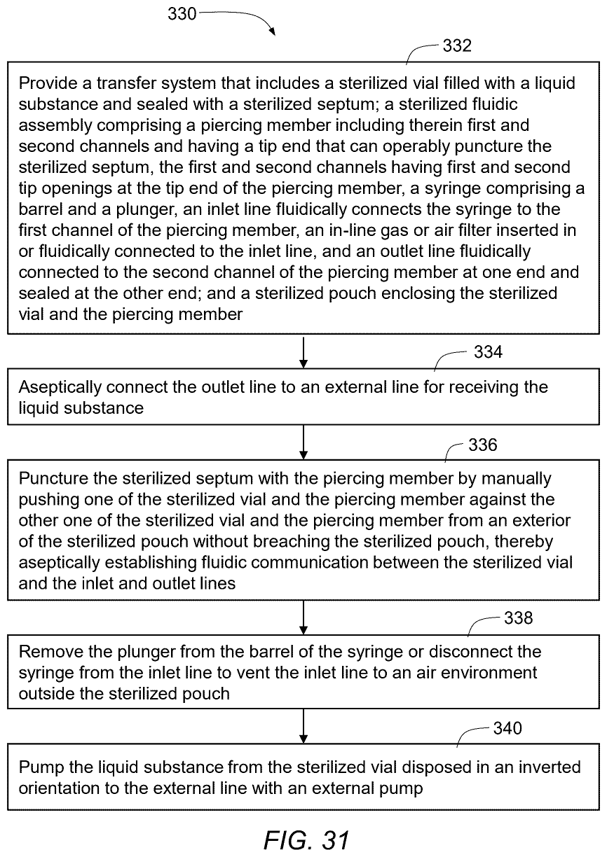

Operation of the system 50 with an external pump will now be described with reference to FIGS. 1, 30, and 31. The flow diagram of FIG. 31 illustrates selected steps 330 for using the system 50 to aseptically transfer a liquid substance from a vial in accordance with an embodiment of the present invention. The process begins at step 332 by providing a transfer system 50 that includes a sterilized vial 52 filled with a liquid substance 54 and sealed with a sterilized septum 56; a sterilized fluidic assembly comprising a piercing member 58 including therein first and second channels 60, 62 and having a tip end 64 that can operably puncture through the sterilized septum 56, the first and second channels 60, 62 having first and second tip openings at the tip end 64 of the piercing member 58, a syringe 66 comprising a barrel and a plunger fitted in the barrel, an inlet line 72 that fluidically connects the syringe 66 to the first channel 60 of the piercing member 58, an in-line gas or air filter 78 inserted between segments of the inlet line 72 for filtering air flowing through the inlet line 72, and an outlet line 74 fluidically connected to the second channel 62 of the piercing member 58 at one end and sealed close at the other end; and a sterilized pouch 68 enclosing the sterilized vial 52 and the piercing member 58.

The system 50 may further include a sterilized holder 70. The sterilized vial 52 and the piercing member 58 may be separately mounted on a sterilized holder 70 that provides a guiding mechanism for the piercing member 58 to puncture the sterilized septum 56 of the sterilized vial 52 in the sterilized pouch 68. The sterilized holder 70, together with the sterilized vial 52 and the piercing member 58, may be sealed in or enclosed by the sterilized pouch 68. The sterilized holder 70 may be made of any moldable material that has sufficient mechanical rigidity and can withstand the sterilization process, such as but not limited to thermoplastic materials.

Next, at step 334, the outlet line 74 is aseptically connected to an external line 84 for receiving the liquid substance 54. The other end of the external line 84 may be connected to a receiving container (not shown). For the outlet line 74 sealed by thermal welding, this may be carried out by using a commercial tube welder that maintains the sterility of the connection. For the outlet line 74 that uses an aseptic connector, this may be carried out by connecting the male or female half of the aseptic connector 76 attached to the free end of the outlet line 74 to the opposite half of the aseptic connector 76 attached to the external line 84.

At step 336, the sterilized septum 56 is punctured with the piercing member 58 by manually pushing one of the sterilized vial 52 and the piercing member 58 against the other one of the sterilized vial 52 and the piercing member 58 from an exterior of the sterilized pouch 68 without breaching the sterilized pouch 68, thereby aseptically establishing fluidic communications between the sterilized vial 52 and the inlet and outlet lines 72, 74.

At step 338, the plunger of the syringe 66 is removed from the barrel to vent the inlet line 72 to the air environment outside the sterilized pouch 68, thereby enabling fluidic communication between the chamber of the sterilized vial 52 and the air environment outside the sterilized pouch 68. Alternatively, the syringe 66 attached to the end of the inlet line 72 may be simply severed or disconnected from the inlet line 72 to vent the inlet line 72 to the air environment outside the sterilized pouch 68. The in-line air filter 78 may be used to preserve the sterility in the chamber of the sterilized vial 52 as air flows into the chamber during the transfer operation. Steps 334, 336, and 338 may be carried out in any order or simultaneously.

After steps 334-338, the liquid substance 54 in the sterilized vial 52, oriented in an inverted position (i.e., the tip opening of the second channel 62 of the piercing member 58 is submerged in the liquid substance 54), is pumped through the outlet line 74 and the external line 84 and into the receiving container (not shown) by an external pump (not shown) at step 340. For example, the external pump may be a peristaltic pump engaging the external line 84 or an in-line pump fluidically connected to the external line 84. As the liquid substance 54 flows out of the sterilized vial 52, the inlet line 72 allows air to flow from outside the sterilized pouch 68 into the chamber of the sterilized vial 52, thereby equilibrating the pressure inside the chamber to facilitate the flow of the liquid substance 54. If only a portion of the liquid substance 54 in the sterilized vial 52 needs to be transferred to the receiving container, the sterilized vial 52 may be reoriented in an upright position (i.e., the tip opening of the second channel 62 of the piercing member 58 is not covered by the liquid substance 54) after the portion of the liquid substance 54 has been transferred out of the sterilized vial 52. After the sterilized vial 52 is reoriented in the upright position, the pumping of the liquid substance 54 by the external pump may continue to extract the residual liquid substance 54 remaining in the outlet line 74 and the external line 84 into the receiving container without further draining the liquid substance 54 remaining in the sterilized vial 52.

The present invention allows the aseptic transfer process described herein to be carried out in a non-aseptic or non-sterile environment because the sterilized vials 52, 52A, 52B and the piercing members 58, 58A, 58B are enclosed by the sterilized pouch 68, which maintains a sterile environment inside the sterilized pouch 68. Fluidic communications can be established between the sterilized vials 52, 52A, 52B and the inlet and outlet lines 72, 72A, 72B, 74, 74A, 74B, 74C in the sterilized pouch 68 regardless of the environment outside the sterilized pouch 68.

While the present invention has been shown and described with reference to certain preferred embodiments, it is to be understood that those skilled in the art will no doubt devise certain alterations and modifications thereto which nevertheless include the true spirit and scope of the present invention. Thus the scope of the invention should be determined by the appended claims and their legal equivalents, rather than by examples given.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

What is claimed is:

1. A system for aseptically transferring a liquid substance comprising:
a sterilized vial filled with the liquid substance and sealed with a sterilized septum;
a sterilized fluidic assembly comprising:
a piercing member including therein first and second channels and having a tip end that operably punctures the sterilized septum, the first and second channels having first and second tip openings at the tip end of the piercing member, respectively; and
an outlet line fluidically connected to the second channel of the piercing member at one end and sealed at the other end; and
a sterilized pouch enclosing the sterilized vial and the piercing member and operably allowing the piercing member to puncture the sterilized septum without breaching the sterilized pouch when one of the sterilized vial and the piercing member is manually pushed against the other one of the sterilized vial and the piercing member from an exterior of the sterilized pouch.

2. The system of claim 1 further comprising a sterilized holder, wherein the sterilized vial and the piercing member are separately mounted on the sterilized holder that provides a guiding mechanism for the piercing member to puncture the sterilized septum of the sterilized vial in the sterilized pouch without breaching the sterilized pouch.

3. The system of claim 2, wherein the sterilized holder, together with the sterilized vial and the piercing member, is sealed in the sterilized pouch.

4. The system of claim 1, wherein the sterilized fluidic assembly further comprises an inlet line fluidically connected to the first channel of the piercing member and an in-line air filter fluidically connected to the inlet line for filtering air flowing through the inlet line.

5. The system of claim 4, wherein a free end of the inlet line is sealed.

6. The system of claim 4, wherein a free end of the inlet line is disposed outside the sterilized pouch.

7. The system of claim 1, wherein the other end of the outlet line is disposed outside the sterilized pouch.

8. A method of manufacturing a system for aseptically transferring a liquid substance comprising the steps of:
sterilizing a vial and a septum;
aseptically filling the sterilized vial with the liquid substance and sealing the sterilized vial with the sterilized septum;
providing a fluidic assembly that includes:
a piercing member including therein first and second channels and having a tip end that operably punctures the sterilized septum, the first and second channels having first and second tip openings at the tip end of the piercing member; and
an outlet line fluidically connected to the second channel of the piercing member at one end and sealed at the other end;
sterilizing the fluidic assembly; and
assembling the vial and the fluidic assembly and enclosing the vial and the piercing member with a sterilized pouch in an aseptic environment,
wherein the sterilized pouch allows the piercing member to puncture the sterilized septum without breaching the sterilized pouch when one of the sterilized vial and the piercing member is manually pushed against the other one of the sterilized vial and the piercing member from an exterior of the sterilized pouch.

9. The method of claim 8, wherein the sterilized vial and the piercing member are separately mounted on a sterilized holder that provides a guiding mechanism for the piercing member to puncture the sterilized septum of the sterilized vial in the sterilized pouch.

10. The method of claim 9, wherein the sterilized holder, together with the sterilized vial and the piercing member, is enclosed by the sterilized pouch.

11. The method of claim 8, wherein the other end of the outlet line is disposed outside the sterilized pouch.

12. The method of claim 8, wherein the sterilized fluidic assembly further includes an inlet line fluidically connected to the first channel of the piercing member and an in-line air filter for filtering air flowing through the inlet line.

13. A method for aseptically transferring a liquid substance comprising the steps of:
providing a transfer system including:
a sterilized vial filled with the liquid substance and sealed with a sterilized septum;
a sterilized fluidic assembly comprising:
a piercing member including therein first and second channels and having a tip end that operably punctures the sterilized septum, the first and second channels having first and second tip openings at the tip end of the piercing member; and
an outlet line fluidically connected to the second channel of the piercing member at one end and sealed at the other end; and
a sterilized pouch enclosing the sterilized vial and the piercing member;
aseptically connecting the outlet line to an external line for receiving the liquid substance;
puncturing the sterilized septum with the piercing member by manually pushing one of the sterilized vial and the piercing member against the other one of the sterilized vial and the piercing member from an exterior of the sterilized pouch without breaching the sterilized pouch, thereby aseptically establishing fluidic communication between the sterilized vial and the outlet line; and
pumping the liquid substance from the sterilized vial disposed in an inverted orientation to the external line using a pump.

14. The method of claim 13, wherein the sterilized vial and the piercing member are separately mounted on a sterilized holder that provides a guiding mechanism for the piercing member to puncture the sterilized septum in the sterilized pouch.

15. The method of claim 14, wherein the sterilized holder, together with the sterilized vial and the piercing member, is enclosed by the sterilized pouch.

16. The method of claim 13, wherein the pump is a peristaltic pump engaging the external line.

17. The method of claim 13, wherein the pump is fluidically connected to the external line.

18. The method of claim 13, wherein the other end of the outlet line is disposed outside the sterilized pouch.

19. The method of claim 13, wherein the sterilized fluidic assembly further includes an inlet line fluidically connected to the first channel of the piercing member and an in-line air filter for filtering air flowing through the inlet line.

20. The method of claim 19, wherein a free end of the inlet line is disposed outside the sterilized pouch.
